(19) United States
(12) Patent Application Publication
(10) Pub. No.: US 2025/0208293 A1
(43) Pub. Date: Jun. 26, 2025

(54) DETERMINING OBJECT DIMENSION USING OFFSET PIXEL GRIDS

(71) Applicant: INNOVIZ TECHNOLOGIES LTD, Rosh HaYain (IL)

(72) Inventors: Avishay MOSCOVICI, Tel Aviv (IL); Omer David KEILAF, Kfar Saba (IL); Nir GOREN, Herut (IL); Ronen ESHEL, Herzliya (IL); Omri TENNENHAUS, Jerusalem (IL)

(21) Appl. No.: 18/847,609

(22) PCT Filed: Mar. 16, 2023
(86) PCT No.: PCT/IL2023/050278

§ 371 Date: Sep. 16, 2024

Related U.S. Application Data
(60) Provisional application No. 63/320,294, filed on Mar. 16, 2022.

(51) Int. Cl. G01S 17/42; G01S 7/481; G01S 7/4861; G01S 17/89; G01S 17/931

(52) U.S. Cl. CPC G01S 17/42; G01S 7/4817; G01S 7/4861; G01S 17/89; G01S 17/931

(57) ABSTRACT

Receiving LIDAR measurement data including object pixel data corresponding to measurement of an object, the object pixel data including a plurality of data pixels corresponding to an edge of the object, the plurality of data pixels including at least two pixels adjacent to each other in a first direction where the at least two pixels are offset from each other in a second direction by an offset distance which is less than a dimension of at least one of the at least two pixels in a second direction, where at least one outer pixel of the at least two pixels extends by the offset away from an outer edge of at least one inner pixel of the at least two pixels; determining a location of the edge of the object to truncate an extent of the object from that of the plurality of data pixels.

### TECHNOLOGICAL FIELD

The present disclosure relates generally to surveying technology for scanning a surrounding environment, and, more specifically, to systems and methods that use LIDAR technology to detect objects in the surrounding environment.

### BACKGROUND ART

Background art includes US Patent Application Publication No. US2021/0356600 which discloses “a lidar system includes a light source configured to emit pulses of light and a scanner configured to scan the emitted pulses of light along a high-resolution scan pattern located within afield of regard of the lidar system. The scanner includes one or more scan mirrors configured to (i) scan the emitted pulses of light along a first scan axis to produce multiple scan lines of the high-resolution scan pattern, where each scan line is associated with multiple pixels, each pixel corresponding to one of the emitted pulses of light and (ii) distribute the scan lines of the high-resolution scan pattern along a second scan axis. The high-resolution scan pattern includes one or more of: interlaced scan lines and interlaced pixels.”

Additional background art includes US2018/0059222, U.S. Pat. No. 11,237,256, US Patent Application Publication No. US2017/0131387, US Patent Application Publication No. US2020/0166645, US Patent Application Publication No. US2020/0166612, International Patent Application Publication No. WO2017/112416, US Patent Application Publication No. US2021/0181315, U.S. Pat. No. 4,204,230, Chinese Patent Document No. CN104301590, Chinese Patent Document No. CN108593107, Chinese Patent Document No. CN106813781, International Patent Application Publication No. WO2019/211459, US Patent Application Publication No. US2003/0146883 and International Patent Application Publication No. WO2005/072612.

Acknowledgement of the above references herein is not to be inferred as meaning that these are in any way relevant to the patentability of the presently disclosed subject matter.

### General Description

Following is a non-exclusive list of some exemplary embodiments of the disclosure. The present disclosure also includes embodiments which include fewer than all the features in an example and embodiments using features from multiple examples, even if not listed below.

Example 1. A method of processing LIDAR measurement data comprising:
receiving the LIDAR measurement data including object pixel data corresponding to measurement of an object, the object pixel data including a plurality of data pixels at an edge of the object, the plurality of data pixels including at least two pixels adjacent to each other in a first direction where, for each distance away from a light source, for a range of distances, the at least two pixels are offset from each other in a second direction by less than a dimension of at least one of the at least two pixels in a second direction, where at least one outer pixel of the at least two pixels extends by the offset away from an outer edge of at least one inner pixel of the at least two pixels;
determining a location of the edge of the object as located within an outer edge of the at least one inner pixel, to truncate an extent of the object from that of the plurality of data pixels.

Example 2. The method according to Example 1, wherein the outer pixel is truncated by the offset distance.

Example 3. The method according to any one of Examples 1-2, wherein each pixel of the object pixel data has a first pixel dimension in the first direction and a second pixel dimension in the second direction, the offset being less than the second pixel dimension.

Example 4. The method according to Example 3, wherein the first direction corresponds to a horizontal direction, the second direction corresponds to a vertical direction, the first pixel dimension is a pixel width and the second pixel dimension is a pixel height.

Example 5. The method according to any one of Examples 1-4, comprising determining a confidence level of the location of the edge of the object.

Example 6. The method according to Example 5, wherein the object pixel data comprises reflection intensity data for one or more pixel of the object;
wherein the determining a confidence level comprises using the reflection intensity data.

Example 7. The method according to any one of Examples 1-7, wherein the at least two pixels are adjacent to each other in the first direction, and the at least two pixels are offset from each other in the second direction by the offset distance, for each distance away from a system providing the measurement data, for a range of distances.

Example 8. The method according to any one of examples 1-7, wherein the object pixel data comprises intensity data for one or more pixel of the object;
wherein the determining the location of the edge of the object comprises using the intensity data.

Example 9. The method according to Example 8, wherein the determining the location of the edge of the object comprises:
identifying one or more filled pixels of the object;
using an intensity value of the one or more filled pixels to determine a proportion of one or more edge pixels of the object pixel data filled by the object to determine the position of the edge.

Example 10. The method according to any one of Examples 1-9, wherein the receiving comprises:
receiving a grid of measurement data, the grid corresponding to a field of view (FOV) of a LIDAR system and including a plurality of pixels; and
identifying the object pixel data as a cluster of activated pixels in the grid.

Example 11. The method according to Example 10, wherein the measurement data includes reflection intensity, for each pixel of the grid; and
wherein an activated pixel is a grid pixel having a reflection intensity of over a threshold intensity.

Example 12. The method according to any one of Examples 1-11, wherein, for a distance of the object from the LIDAR system associated with a speed of movement of the LIDAR system, the pixel height is larger than a height of an over-drivable obstacle.

Example 13. The method according to Example 12, wherein the distance is that required for obstacle avoidance at the speed.

Example 14. The method according to any one of Examples 1-13, wherein the receiving comprises acquiring measurement data by scanning pulses of laser light across a field of view (FOV) and sensing reflections of the pulses of laser light from one or more object within the FOV.

Example 15. The method according to Example 14, wherein illumination of the pulses of laser light is selected so that, for a range of measurement distances, pulses continuously cover the FOV.

Example 16. The method according to any one of Examples 14-15, wherein the scanning comprises: scanning a first scan line where FOV pixels are aligned horizontally; and
scanning a second scan line where FOV pixels are positioned vertically between FOV pixels of the first scan line and displaced by a proportion of a pixel height.

Example 17. The method according to any one of Examples 14-16, wherein the scanning comprises, scanning a row where, between emissions of the pulses of laser light, changing a direction of emission in a first distance in a first direction and a second distance in a second direction, where for a first portion of the row, the first distance is a positive value in the first direction and the second distance is a positive value in the second direction and for a second portion of the row, the first distance is a negative value in the first direction and the second distance is a positive value in the second direction.

Example 18. The method according to Example 17, wherein the changing a direction of emission comprises rotating a deflector, where rotation around a first axis changes direction of emission in the first direction and rotation around a second axis changes direction of emission in the second direction.

Example 19. The method according to Example 18, wherein changing a direction of emission comprises receiving a control signal driving the rotation.

Example 20. The method according to Example 19, wherein a first signal drives rotation in the first direction, the first signal including a square wave.

Example 21. The method according to Example 19, wherein a first signal drives rotation in the first direction, the first signal including a sinusoid.

Example 22. A LIDAR system comprising:
a light source configured to emit pulses of light;
a deflector configured to direct light pluses from the light source towards a field of view (FOV), each pulse corresponding to a FOV pixel having a pixel first dimension in a first direct and a pixel second dimension in a second direction;
a sensor configured to sense intensity of the light pulses reflected from objects within the FOV; and
a processor configured to:
   control the deflector to direct the light pulses to scan the FOV where adjacent FOV pixels in the first direction are displaced by an offset in the second direction from each other by a proportion of the pixel dimension;
   identify an object within the FOV as a cluster of the FOV pixels having higher intensity, where an edge of the cluster has at least one inner pixel and at least one outer pixel; and
   determine a location of an edge of the object as within an outer edge of the at least one inner pixel, to truncate an extent of the object from that of the cluster.

Example 23. The LIDAR system according to Example 22, wherein the offset is less than 50% of the pixel second dimension.

Example 24. The LIDAR system according to any one of Example 22-23, wherein the light source and the deflector are configured to produce light pulses where the illumination of the pulses of laser light is configured to, for a range of measurement distances, continuously cover the FOV.

Example 25. The LIDAR system according to any one of Examples 22-24, wherein said processor is configured to control the deflector to scan rows where consecutively emitted pixels are aligned in the second direction and separated by the first dimension in the first direction; and
wherein each row is offset in a first dimension in the first direction from adjacent rows.

Example 26. The LIDAR system according to any one of Examples 22-24, wherein the processor is configured to control the deflector to scan rows where for a first portion of the row consecutively emitted pixels are separated by a first distance having a positive value in the first direction and a second distance in the second direction where the second distance is a positive value in the second direction and for a second portion of the row, the first distance is a negative value in the first direction and the second distance is a negative value in the second direction.

Example 27. The LIDAR system according to any one of Examples 22-24, wherein deflector is configured to direct light by rotation of the deflector, where rotation around a first axis changes direction of emission in the first direction and rotation around a second axis changes direction of emission in the second direction.

Example 28. The LIDAR system according to Example 27, wherein a first signal drives rotation in the first direction, and the first signal includes a square wave.

Example 29. The LIDAR SYSTEM according to Example 27, wherein a first signal drives rotation in the first direction, and the first signal includes a sinusoid.

Example 30. A LIDAR system comprising:
a light source configured to emit pulses of light;
a deflector configured to direct light pluses from the light source towards a field of view (FOV), each pulse corresponding to a FOV pixel having a pixel first dimension in a first direct and a pixel second dimension in a second direction;
a sensor configured to sense intensity of the light pulses reflected from objects within the FOV; and
a processor configured to:
   control the deflector to direct the light pulses to scan the FOV where adjacent FOV pixels in the first direction are displaced by an offset in the second direction from each other by a proportion of the pixel dimension;
wherein the light source and the deflector are configured to produce light pulses where illumination of the pulses of laser light is configured to, for a range of measurement distances, continuously cover the FOV.

Example 31. A LIDAR system comprising:
a light source configured to produce pulses of laser light;
a deflector configured to direct the pulses towards a field of view (FOV) of the LIDAR system, each pulse corresponding to a FOV pixel having, for each distance away from the light source, for a range of distances, a pixel height and a pixel width; and
a processor configured to control the deflector to scan the FOV along a plurality of scan lines, each scan line produced by directing sequential pulses a region of the FOV incrementally displaced both horizontally, by the pixel width, and vertically by a proportion of the pixel width, each scan line including a first portion and a second portion where vertical displacement of pulses of the first and second portions is inverted. Unless otherwise defined, all technical and/or scientific terms used within this document have meaning as commonly understood by one of ordinary skill in the art/s to which the present disclosure pertains. Methods and/or materials similar or equivalent to those described herein can be used in the practice and/or testing of embodiments of the present disclosure, and exemplary methods and/or materials are described below. Regarding exemplary embodiments described below, the materials, methods, and examples are illustrative and are not intended to be necessarily limiting.

Some embodiments of the present disclosure are embodied as a system, method, or computer program product. For example, some embodiments of the present disclosure may take the form of an entirely hardware embodiment, an entirely software embodiment (including firmware, resident software, micro code, etc.) or an embodiment combining software and hardware aspects that may all generally be referred to herein as a “circuit,” “module” and/or “system.” Implementation of the method and/or system of some embodiments of the present disclosure can involve performing and/or completing selected tasks manually, automatically, or a combination thereof.

According to actual instrumentation and/or equipment of some embodiments of the method and/or system of the present disclosure, several selected tasks could be implemented by hardware, by software or by firmware and/or by a combination thereof, e.g., using an operating system. For example, hardware for performing selected tasks according to some embodiments of the present disclosure could be implemented as a chip or a circuit. As software, selected tasks according to some embodiments of the present disclosure could be implemented as a plurality of software instructions being executed by a computational device e.g., using any suitable operating system. In some embodiments, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage e.g., for storing instructions and/or data. Optionally, a network connection is provided as well. User interface/s e.g., display/s and/or user input device/s are optionally provided. Some embodiments of the present disclosure may be described below with reference to flowchart illustrations and/or block diagrams. For example illustrating exemplary methods and/or apparatus (systems) and/or and computer program products according to embodiments of the present disclosure. It will be understood that each step of the flowchart illustrations and/or block of the block diagrams, and/or combinations of steps in the flowchart illustrations and/or blocks in the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart steps and/or block diagram block or blocks. These computer program instructions may also be stored in a computer readable medium that can direct a computer (e.g., in a memory, local and/or hosted at the cloud), other programmable data processing apparatus, or other devices to function in a particular manner, such that the instructions stored in the computer readable medium can be used to produce an article of manufacture including instructions which implement the function/act specified in the flowchart and/or block diagram block or blocks. The computer program instructions may also be run by one or more computational device to cause a series of operational steps to be performed e.g., on the computational device, other programmable apparatus and/or other devices to produce a computer implemented process such that the instructions which execute provide processes for implementing the functions/acts specified in the flowchart and/or block diagram block or blocks. Some of the methods described herein are generally designed only for use by a computer, and may not be feasible and/or practical for performing purely manually, by a human expert. A human expert who wanted to manually perform similar tasks, might be expected to use different methods, e.g., making use of expert knowledge and/or the pattern recognition capabilities of the human brain, potentially more efficient than manually going through the steps of the methods described herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a simplified schematic of a system, according to some embodiments of the disclosure;

FIG. 1B is a simplified schematic illustrating use of a LIDAR system, according to some embodiments of the disclosure;

FIGS. 2A-C are simplified schematics of a LIDAR pixel grid, according to some embodiments of the disclosure;

FIGS. 3A-C are simplified schematics of a LIDAR pixel grid, according to some embodiments of the disclosure;

FIG. 3D is a simplified schematic of a LIDAR pixel grid, according to some embodiments of the disclosure;

FIG. 3E is a simplified schematic of a LIDAR pixel grid, according to some embodiments of the disclosure;

FIG. 4 is a method of processing LIDAR measurement data, according to some embodiments of the disclosure;

FIGS. 5A-C are simplified schematics of a LIDAR pixel grid, according to some embodiments of the disclosure;

FIG. 6 is a method of determining an object boundary in LIDAR pixel data, according to some embodiments of the disclosure;

FIG. 7 is a method of processing LIDAR pixel data, according to some embodiments of the disclosure;

FIGS. 8A-B are simplified schematics of a LIDAR pixel grid, according to some embodiments of the disclosure;

FIGS. 8C-D are simplified schematics of a pixel grid, according to some embodiments of the disclosure;

FIG. 9 is a simplified schematic of a pixel grid, according to some embodiments of the disclosure;

FIG. 10 is a simplified schematic illustrating control of pixel position, according to some embodiments of the disclosure;

FIG. 11 is a LIDAR scanning method, according to some embodiments of the disclosure;

FIGS. 12A-D are simplified schematics illustrating successive acquisition of pixels of a LIDAR pixel grid, according to some embodiments of the disclosure;

FIGS. 13A-B are simplified schematics of a LIDAR pixel grid, according to some embodiments of the disclosure; and

FIG. 14 is a simplified schematic of a LIDAR pixel grid, according to some embodiments of the disclosure.

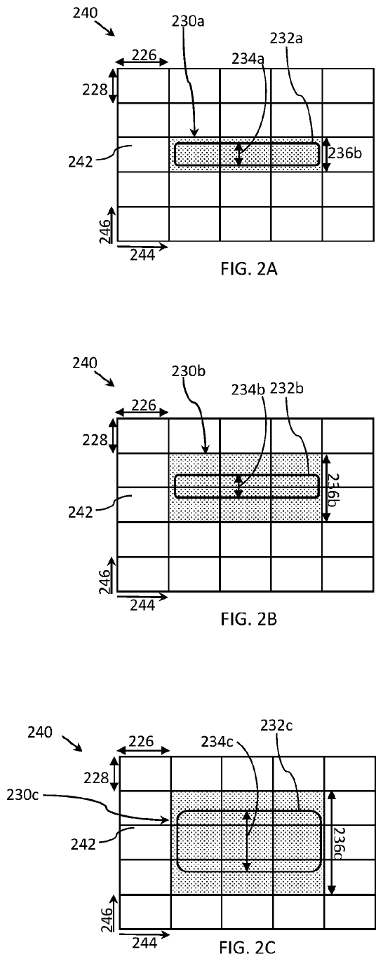

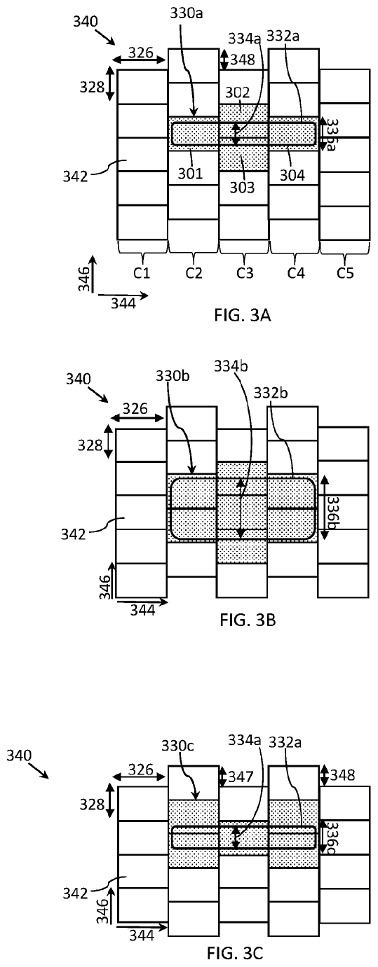

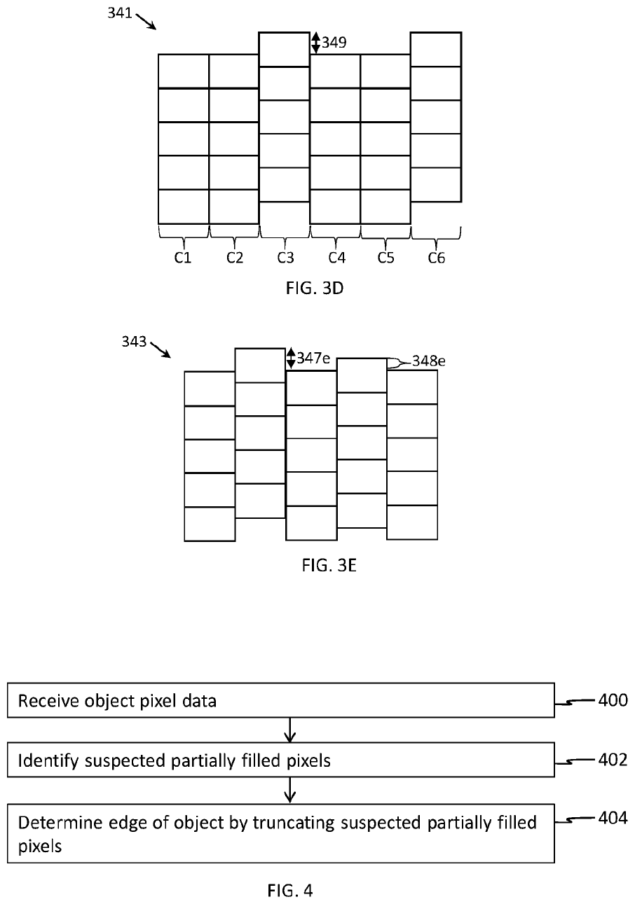

In some embodiments, although non-limiting, in different figures, like numerals are used to refer to like elements, for example, element 240 in FIG. 2A corresponding to element 340 in FIG. 3A.

### DETAILED DESCRIPTION OF EMBODIMENTS

The present disclosure relates generally to surveying technology for scanning a surrounding environment, and, more specifically, to systems and methods that use LIDAR technology to detect objects in the surrounding environment.

### Overview

A broad aspect of some embodiments of the disclosure relates to determining dimensions of objects using LIDAR (Light Detection and Ranging) measurement data including a plurality of measurement pixels, to a smaller resolution than provided by a size of the pixels. Where, in some embodiments, a beam spot formed by a transmitted laser beam (transmitted from a LIDAR system light source) at a certain point of time illuminates a region of space which we will denote a “pixel”. Objects present within and illuminated in the pixel reflect light towards a LIDAR sensing unit, where, if within a time duration after a LIDAR pulse of light is emitted, a corresponding reflected pulse of light is received and/or detected a data pixel corresponding to the real space pixel is termed “activated”. Where the term “data pixel” refers to data associated with measurement of a real space pixel. Where, in some embodiments, a data pixel includes of a LIDAR measurement signal and/or positioning data regarding position of the pixel within a data pixel grid.

Where pixel size changes (e.g. may be determined) according to a distance to the LIDAR system the increase in size e.g. associated with beam broadening. For simplicity, in this document, at times, pixel size will be described using angles, where the angle is a measure of an angle difference between directions of emission of light which corresponds to pixel size but (theoretically) does not vary with distance.

An aspect of some embodiments of the disclosure relates to using a geometry of edge pixels of an object, where the geometry includes offset pixels, to determine a position of the edge of the object as within a region of space occupied by pixels of the object edge. For example, where one or more edge pixel of the object overhangs and/or is truncated by the determined position of the edge. In some embodiments, the edge position is determined by assuming that edge geometry varies less than a shape provided by activated pixels of the object.

Where, in some embodiments, the term “offset pixels” refers to pixels within a data grid (or portion of a data grid), the data grid herein termed an “offset grid” where the pixels are not aligned or are “offset” by a distance from each other in at least one direction. For example, where one or more column (or row, where columns and rows are together, in some embodiments, termed “scan lines”) of pixels aligned in a first direction is displaced by a distance in the first direction (e.g. vertically) from other column/s. Where the displacement (also termed “offset”) is by a distance which is less than a pixel dimension in the first direction (e.g. height) where, in some embodiments, the pixels of the grid have a same dimension in the first direction (e.g. a same height).

In some embodiments the edge is determined as being within (e.g., not extending to) a space delineated by borders of the edge pixels of the object. Where, in some embodiments, an object is identified as a cluster of activated pixels. Where the cluster of object pixels, in some embodiments, includes edge pixels, each edge pixel having an adjacent pixel which is not activated (not part of the object). Where the cluster of object pixels, in some embodiments, (e.g. only over a certain object size) has central pixels where located in a central region of the object luster and/or has adjacent pixels which are activated and/or considered to be part of the object.

Where adjacent pixels to a first pixel are defined, in some embodiments, as those pixels sharing a pixel boundary with the first pixel and/or those pixels most closely located with respect to the first pixel.

In some embodiments, where the edge pixels of the object include offset pixels having a varying position (e.g. in one direction). Where the edge includes including inner and outer edge pixels, the outer pixels extending further away from a central region (e.g. including central pixel/s) of the object. In some embodiments, it is assumed that the edge of the detected object lies at a border indicated by a border of the inner pixels of the edge. Where, for example, in some embodiments, a space encompassed by the activated pixels corresponding to the object is truncated, by a portion of a pixel (e.g. the offset dimension), based on an assumption of relative flatness of the object edge.

In some embodiments, a confidence level of a determined position of an object edge is determined. For example, based on geometry and/or numbers of pixels at the edge. Optionally, additional pixel data is used to adjust and/or determine the confidence level, for example, one or more of intensity data (described below), shape of reflected pulses, grazing angle (e.g. as determined from reflected pulse shape), signal to noise ratio (SNR), and reflectivity of the object.

In some embodiments, pixels of the pixel grid cover a continuous space, e.g. with at most small spaces between pixels. Where, in some embodiments, this holds for different measurement distances between the LIDAR system and objects in the field of view (FOV) of the LIDAR system. Where, in some embodiments, direction of beam for pixels of the grid and broadening of the beam with distance are selected to provide such full measurement coverage of the FOV, for a range of distances to the LIDAR system. Where, in some embodiments, the range is 1-300 m, or 1-200 m, or 5-150 m, or 20-150 m, or lower or higher or intermediate distances or ranges. In some embodiments, pixels of the pixel grid cover a continuous space, e.g. as defined as there being at most an angle of 0.0001-0.01 degrees, or at most 0.0005-0.005 degrees between pixels (e.g. edge border/s of pixels) in one or more direction.

In some embodiments, although illustrated by adjacent rectangular shapes, illumination pulse beams have rounded shapes (the shape e.g. rounding with distance from the light source). In some embodiments, an extent of the pixel is taken to be a central region of the light encompassing 80-95%, or 85-95%, or about 90% of the beam energy. Where, for example, in some embodiments, a pixel width as described and/or discussed within this document refers to a central width dimension having 80-95%, or 85-95%, or about 90% a real width of the light pulse beam. In some embodiments, spaces between pixels are by at most 10%, or 5%, or 1%, or lower or higher or intermediate percentages of a pixel width (e.g. as defined by energies above).

In some embodiments, adjacent pixels are illustrated as sharing a border, where this refers, in some embodiments, to sharing a border of the pixel (being immediately adjacent) where, in practice, illumination of adjacent pulses overlaps (e.g. by 5-15%, or about 10% of the pixel width and/or pixel energies).

A potential benefit of using offset pixels to determine an object edge is reduction of oversizing of a detected object associated with particular alignments between real object borders and that of the pixels. Where “oversizing” is defined as determining a dimension of an object as larger than the real object dimension. For example, in cases where an edge of the object has a similar orientation to a direction of orientation of pixel edges. For example, where the object is a generally horizontally orientated object having a relatively flat top surface e.g. tires, person laying down. For example, oversizing associated with similar alignment of the object edge with the pixel scan lines e.g., as offsetting of the pixels reduces an extent of contiguous pixel boundaries (for example, preventing horizontal scan lines aligning with rectangular objects on the road).

A broad aspect of some embodiments of the disclosure relates to using pixel intensity information to determine boundaries of an object. In some embodiments, an object is assumed to have low variation in its reflectivity and/or intensity of object pixels is used to determine a proportion of the object present in pixel space/s.

An aspect of some embodiments of the invention relates to determining a position of an edge of an object where intensity (e.g., associated with reflectivity values) of edge pixels is assumed to indicate a proportion of the object being within a real space associated with the measurement pixel herein termed the proportion of the pixel “filled” by the object, also herein termed the proportion of the pixel “overlapped” by the object. Where, in some embodiments, a reflectivity of the object is determined using measurement intensities of those pixels considered to be fully occupied by the object, e.g., central pixel/s of the object. In some embodiments, proportion of filling of suspected partially filled edge pixels of the object are determined using the intensities of the filled pixels. An edge of the object, the being positioned to enclose a volume of the partially filled pixel within the object boundary where the volume is proportional to the filling of the pixel.

An aspect of some embodiments of the disclosure relates to using both offset pixel activation geometry and reflectivity values to determine a position of an edge of an object. Where, in some embodiments, activation geometry is used to identify which pixels are partially filled by the object and reflectivity values are used to determine the proportion of the partially filled pixel/s which are occupied by the object. Reflectivity values, in some embodiments, being used to increase accuracy and/or reduce uncertainty of determining of the edge position.

In some embodiments, intensity data is used to adjust a confidence level as to positioning of an edge of an object using offset pixel geometry of the edge. For example, where suspected partially filled edge pixels are truncated, matching intensity values indicating that these truncated pixels are indeed partially filled increases the confidence level. In some embodiments, additionally or alternatively, the intensity levels are used to adjust a position of the edge. Where, in some embodiments, a border of a object edge is positioned to enclose within the object a volume of a pixel proportional to a proportion of the object filled (e.g. as determined using intensity of the partially filled pixel with respect to filled object pixel/s).

In some embodiments, sub-pixel resolution technique/s are used in situations where oversizing of object dimension/s, e.g. where a ‘false positive’ is reported, of an object with a height ‘H’ where the actual height is less than ‘H’, results in one or more of unnecessary braking, emergency braking, and/or changing of route of a vehicle hosting. In some embodiments, increased accuracy of determining dimensions is used to distinguish between small in-route obstacles which may be over-driven and larger obstacles that potentially require braking and/or re-routing of the vehicle e.g. to safely avoid driving over the obstacle.

In some embodiments, sub-pixel resolution technique/s are used for objects at a distance from the LIDAR system where the pixel size is of an order of magnitude that oversizing associate with the pixel size is sufficient to produce false positives in terms of identifying over-drivable obstacles.

For example, where, for a vehicle speed, resolution at a distance at which an object needs to be correctly identified as over-drivable or not (the distance increases with speed), for safe and/or comfortable braking and/or re-routing, double the pixel height is larger than an over-drivable dimension while a single pixel height is over-drivable. For example, if the object has a pixel height it is over-drivable, but if it has a two pixel height it is not over-drivable. Meaning that, in an aligned grid without offset pixels, depending on alignment with the grid, the object may be incorrectly sized as having a two pixel height potentially producing a false positive breaking/re-routing event. Whereas, using offset pixels and truncation of activated pixels, the object, in some embodiments, is correctly determined to have a single pixel height.

In an exemplary use case, a vehicle travelling at 100-120 kph, is able to detect a height of a tire on the road from 100 m away from the tire. Additionally or alternatively, the vehicle travelling at 60 kph is able to identify a tire or determine whether a borderline object is over-drivable at 40 m away from the object.

In an exemplary example, at distances of is more than 60 m, or between 60-100 m away from the LIDAR system (and/or vehicle), the object is resting on a road surface; and the object is within 5 cm of a size which is deemed not over-drivable e.g., 14 cm.

In an exemplary embodiment, for driving speeds of >120 kph (e.g., 130 kph) over-drivability of obstacles is determined from a distance of about 100 m.

“Small obstacle” will be used to denote obstacles that could be over-driven and have a height of ˜<15 cm (i.e. in the vertical dimension). The term “large obstacle” will denote obstacles with a height of ˜>14 cm. Objects larger than ˜20 cm will be noted as “huge obstacle”.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Terms Definitions

Disclosed embodiments may involve an optical system. As used herein, the term “optical system” broadly includes any system that is used for the generation, detection and/or manipulation of light. By way of example only, an optical system may include one or more optical components for generating, detecting and/or manipulating light. For example, light sources, lenses, mirrors, prisms, beam splitters, collimators, polarizing optics, optical modulators, optical switches, optical amplifiers, optical detectors, optical sensors, fiber optics, semiconductor optic components, while each not necessarily required, may each be part of an optical system. In addition to the one or more optical components, an optical system may also include other non-optical components such as electrical components, mechanical components, chemical reaction components, and semiconductor components. The non-optical components may cooperate with optical components of the optical system. For example, the optical system may include at least one processor for analyzing detected light.

Consistent with the present disclosure, the optical system may be a LIDAR system. As used herein, the term “LIDAR system” broadly includes any system which can determine values of parameters indicative of a distance between a pair of tangible objects based on reflected light. In one embodiment, the LIDAR system may determine a distance between a pair of tangible objects based on reflections of light emitted by the LIDAR system.

As used herein, the term “determine distances” broadly includes generating outputs which are indicative of distances between pairs of tangible objects. The determined distance may represent the physical dimension between a pair of tangible objects. By way of example only, the determined distance may include a line of flight distance between the LIDAR system and another tangible object in a field of view of the LIDAR system. In another embodiment, the LIDAR system may determine the relative velocity between a pair of tangible objects based on reflections of light emitted by the LIDAR system. Examples of outputs indicative of the distance between a pair of tangible objects include: a number of standard length units between the tangible objects (e.g., number of meters, number of inches, number of kilometers, number of millimeters), a number of arbitrary length units (e.g., number of LIDAR system lengths), a ratio between the distance to another length (e.g., a ratio to a length of an object detected in a field of view of the LIDAR system), an amount of time (e.g., given as standard unit, arbitrary units or ratio, for example, the time it takes light to travel between the tangible objects), one or more locations (e.g., specified using an agreed coordinate system, specified in relation to a known location), and more.

The LIDAR system may determine the distance between a pair of tangible objects based on reflected light. In one embodiment, the LIDAR system may process detection results of a sensor which creates temporal information indicative of a period of time between the emission of a light signal and the time of its detection by the sensor. The period of time is occasionally referred to as “time of flight” of the light signal. In one example, the light signal may be a short pulse, whose rise and/or fall time may be detected in reception. Using known information about the speed of light in the relevant medium (usually air), the information regarding the time of flight of the light signal can be processed to provide the distance the light signal traveled between emission and detection. In another embodiment, the LIDAR system may determine the distance based on frequency phase-shift (or multiple frequency phase-shift). Specifically, the LIDAR system may process information indicative of one or more modulation phase shifts (e.g., by solving some simultaneous equations to give a final measure) of the light signal. For example, the emitted optical signal may be modulated with one or more constant frequencies. The at least one phase shift of the modulation between the emitted signal and the detected reflection may be indicative of the distance the light traveled between emission and detection. The modulation may be applied to a continuous wave light signal, to a quasi-continuous wave light signal, or to another type of emitted light signal. It is noted that additional information may be used by the LIDAR system for determining the distance, e.g., location information (e.g., relative positions) between the projection location, the detection location of the signal (especially if distanced from one another), and more.

Consistent with the present disclosure, the term “object” broadly includes a finite composition of matter that may reflect light from at least a portion thereof. For example, an object may be at least partially solid (e.g., cars, trees); at least partially liquid (e.g., puddles on the road, rain); at least partly gaseous (e.g., fumes, clouds); made from a multitude of distinct particles (e.g., sand storm, fog, spray); and may be of one or more scales of magnitude, such as ˜1 millimeter (mm), ˜5 mm, ˜10 mm, ˜50 mm, ˜100 mm, ˜500 mm, ˜1 meter (m), ˜5 m, ˜10 m, ˜50 m, ˜100 m, and so on. Smaller or larger objects, as well as any size in between those examples, may also be detected. It is noted that for 5 various reasons, the LIDAR system may detect only part of the object. For example, in some cases, light may be reflected from only some sides of the object (e.g., only the side opposing the LIDAR system will be detected); in other cases, light may be projected on only part of the object (e.g., laser beam projected onto a road or a building); in other cases, the object may be partly blocked by another object between the LIDAR system and the detected object; in other cases, the LIDAR's sensor may only detects light reflected from a portion of the object, e.g., because ambient light or other interferences interfere with detection of some portions of the object.

Consistent with the present disclosure, a LIDAR system may be configured to detect objects by scanning the environment of LIDAR system. The term “scanning the environment of LIDAR system” broadly includes illuminating the field of view or a portion of the field of view of the LIDAR system. In one example, scanning the environment of LIDAR system may be achieved by moving or pivoting a light deflector to deflect light in differing directions toward different parts of the field of view. In another example, scanning the environment of LIDAR system may be achieved by changing a positioning (i.e. location and/or orientation) of a sensor with respect to the field of view. In another example, scanning the environment of LIDAR system may be achieved by changing a positioning (i.e. location and/or orientation) of a light source with respect to the field of view. In yet another example, scanning the environment of LIDAR system may be achieved by changing the positions of at least one light source and of at least one sensor to move rigidly respect to the field of view (i.e. the relative distance and orientation of the at least one sensor and of the at least one light source remains).

Similarly, the term “instantaneous field of view” may broadly include an extent of the observable environment in which objects may be detected by the LIDAR system at any given moment. For example, for a scanning LIDAR system, the instantaneous field of view is narrower than the entire FOV of the LIDAR system, and it can be moved within the FOV of the LIDAR system in order to enable detection in other parts of the FOV of the LIDAR system. The movement of the instantaneous field of view within the FOV of the LIDAR system may be achieved by moving a light deflector of the LIDAR system (or external to the LIDAR system), so as to deflect beams of light to and/or from the LIDAR system in differing directions. In one embodiment, LIDAR system may be configured to scan scene in the environment in which the LIDAR system is operating. As used herein the term “scene” may broadly include some or all of the objects within the field of view of the LIDAR system, in their relative positions and in their current states, within an operational duration of the LIDAR system. For example, the scene may include ground elements (e.g., earth, roads, grass, sidewalks, road surface marking), sky, man-made objects (e.g., vehicles, buildings, signs), vegetation, people, animals, light projecting elements (e.g., flashlights, sun, other LIDAR systems), and so on.

Any reference to the term “actuator” should be applied mutatis mutandis to the term “manipulator”. Non-limiting examples of manipulators include Micro-Electro-Mechanical Systems (MEMS) actuators, Voice Coil Magnets, motors, piezoelectric elements, and the like. It should be noted that a manipulator may be merged with a temperature control unit.

Disclosed embodiments may involve obtaining information for use in generating reconstructed three-dimensional models. Examples of types of reconstructed three-dimensional models which may be used include point cloud models, and Polygon Mesh (e.g., a triangle mesh). The terms “point cloud” and “point cloud model” are widely known in the art, and should be construed to include a set of data points located spatially in some coordinate system (i.e., having an identifiable location in a space described by a respective coordinate system). The term “point cloud point” refer to a point in space (which may be dimensionless, or a miniature cellular space, e.g., 1 cm³), and whose location may be described by the point cloud model using a set of coordinates (e.g., (X,Y,Z), (r,ϕ,θ)). By way of example only, the point cloud model may store additional information for some or all of its points (e.g., color information for points generated from camera images). Likewise, any other type of reconstructed three-dimensional model may store additional information for some or all of its objects. Similarly, the terms “polygon mesh” and “triangle mesh” are widely known in the art, and are to be construed to include, among other things, a set of vertices, edges and faces that define the shape of one or more 3D objects (such as a polyhedral object). The faces may include one or more of the following: triangles (triangle mesh), quadrilaterals, or other simple convex polygons, since this may simplify rendering. The faces may also include more general concave polygons, or polygons with holes. Polygon meshes may be represented using differing techniques, such as: Vertex-vertex meshes, Face-vertex meshes, Winged-edge meshes and Render dynamic meshes. Different portions of the polygon mesh (e.g., vertex, face, edge) are located spatially in some coordinate system (i.e., having an identifiable location in a space described by the respective coordinate system), either directly and/or relative to one another. The generation of the reconstructed three-dimensional model may be implemented using any standard, dedicated and/or novel photogrammetry technique, many of which are known in the art. It is noted that other types of models of the environment may be generated by the LIDAR system.

Consistent with disclosed embodiments, the LIDAR system may include at least one projecting unit with a light source configured to project light. As used herein the term “light source” broadly refers to any device configured to emit light. In one embodiment, the light source may be a laser such as a solid-state laser, laser diode, a high power laser, or an alternative light source such as, a light emitting diode (LED)-based light source. In addition, light source 112 as illustrated throughout the figures, may emit light in differing formats, such as light pulses, continuous wave (CW), quasi-CW, and so on. For example, one type of light source that may be used is a vertical-cavity surface emitting laser (VCSEL). Another type of light source that may be used is an external cavity diode laser (ECDL). In some examples, the light source may include a laser diode configured to emit light at a wavelength between about 650 nm and nm. Alternatively, the light source may include a laser diode configured to emit light at a wavelength between about 800 nm and about nm, between about 850 nm and about 950 nm, or between about nm and about nm.

Unless indicated otherwise, the term “about” with regards to a numeric value is defined as a variance of up to 5% with respect to the stated value.

Consistent with disclosed embodiments, the LIDAR system may include at least one scanning unit with at least one light deflector configured to deflect light from the light source in order to scan the field of view. The term “light deflector” broadly includes any mechanism or module which is configured to make light deviate from its original path; for example, a mirror, a prism, controllable lens, a mechanical mirror, mechanical scanning polygons, active diffraction (e.g., controllable LCD), Risley prisms, non-mechanical-electro-optical beam steering (such as made by Vscent), polarization grating (such as offered by Boulder Non-Linear Systems), optical phased array (OPA), and more. In one embodiment, a light deflector may include a plurality of optical components, such as at least one reflecting element (e.g., a mirror), at least one refracting element (e.g., a prism, a lens), and so on. In one example, the light deflector may be movable, to cause light deviate to differing degrees (e.g., discrete degrees, or over a continuous span of degrees). The light deflector may optionally be controllable in different ways (e.g., deflect to a degree α, change deflection angle by Δα, move a component of the light deflector by M millimeters, change speed in which the deflection angle changes). In addition, the light deflector may optionally be operable to change an angle of deflection within a single plane (e.g., θ coordinate). The light deflector may optionally be operable to change an angle of deflection within two non-parallel planes (e.g., θ and ϕ coordinates). Alternatively or in addition, the light deflector may optionally be operable to change an angle of deflection between predetermined settings (e.g., along a predefined scanning route) or otherwise. With respect the use of light deflectors in LIDAR systems, it is noted that a light deflector may be used in the outbound direction (also referred to as transmission direction, or TX) to deflect light from the light source to at least a part of the field of view. However, a light deflector may also be used in the inbound direction (also referred to as reception direction, or RX) to deflect light from at least a part of the field of view to one or more light sensors.

Disclosed embodiments may involve pivoting the light deflector in order to scan the field of view. As used herein the term “pivoting” broadly includes rotating of an object (especially a solid object) about one or more axis of rotation, while substantially maintaining a center of rotation fixed. In one embodiment, the pivoting of the light deflector may include rotation of the light deflector about a fixed axis (e.g., a shaft), but this is not necessarily so. For example, in some MEMS mirror implementation, the MEMS mirror may move by actuation of a plurality of benders connected to the mirror, the mirror may experience some spatial translation in addition to rotation. Nevertheless, such mirror may be designed to rotate about a substantially fixed axis, and therefore consistent with the present disclosure it considered to be pivoted. In other embodiments, some types of light deflectors (e.g., non-mechanical-electro-optical beam steering, OPA) do not require any moving components or internal movements in order to change the deflection angles of deflected light. It is noted that any discussion relating to moving or pivoting a light deflector is also mutatis mutandis applicable to controlling the light deflector such that it changes a deflection behavior of the light deflector. For example, controlling the light deflector may cause a change in a deflection angle of beams of light arriving from at least one direction.

Consistent with disclosed embodiments, the LIDAR system may include at least one sensing unit with at least one sensor configured to detect reflections from objects in the field of view. The term “sensor” broadly includes any device, element, or system capable of measuring properties (e.g., power, frequency, phase, pulse timing, pulse duration) of electromagnetic waves and to generate an output relating to the measured properties. In some embodiments, the at least one sensor may include a plurality of detectors constructed from a plurality of detecting elements. The at least one sensor may include light sensors of one or more types. It is noted that the at least one sensor may include multiple sensors of the same type which may differ in other characteristics (e.g., sensitivity, size). Other types of sensors may also be used. Combinations of several types of sensors can be used for different reasons, such as improving detection over a span of ranges (especially in close range); improving the dynamic range of the sensor; improving the temporal response of the sensor; and improving detection in varying environmental conditions (e.g., atmospheric temperature, rain, etc.).

In one embodiment, the at least one sensor includes a SiPM (Silicon photomultipliers) which is a solid-state single-photon-sensitive device built from an array of avalanche photodiode (APD), single photon avalanche diode (SPAD), serving as detection elements on a common silicon substrate. In one example, a typical distance between SPADs may be between about 10 μm and about 50 μm, wherein each SPAD may have a recovery time of between about 20 ns and about 100 ns. Similar photomultipliers from other, non-silicon materials may also be used. Although a SiPM device works in digital/switching mode, the SiPM is an analog device because all the microcells may be read in parallel, making it possible to generate signals within a dynamic range from a single photon to hundreds and thousands of photons detected by the different SPADs. It is noted that outputs from different types of sensors (e.g., SPAD, APD, SiPM, PIN diode, Photodetector) may be combined together to a single output which may be processed by a processor of the LIDAR system.

### Exemplary System

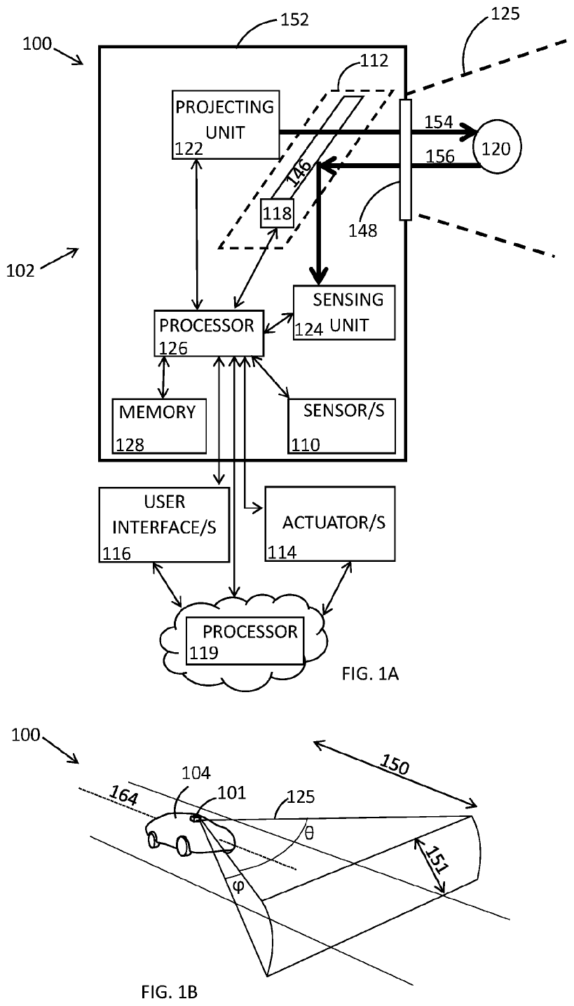

FIG. 1A is a simplified schematic of a system 100, according to some embodiments of the disclosure.

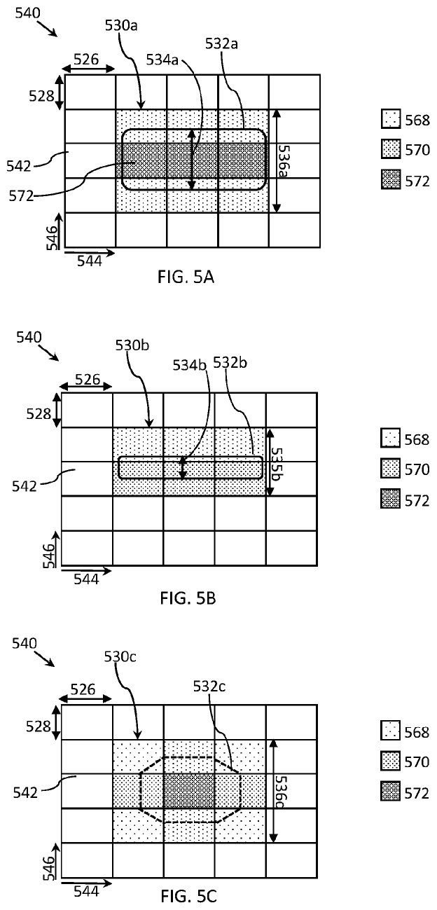

In some embodiments, navigation system 100 includes a LIDAR system 102. In some embodiments LIDAR system 102 acquires LIDAR measurement data. The measurement data, in some embodiments, including one or more feature as described regarding data received in step 400 FIG. 4 and/or step 500 FIG. 5.

In some embodiments, LIDAR system 102 includes a housing 152 which at least partially contains one or more element of LIDAR system 102.

LIDAR system 102, in some embodiments, collects measurement by scanning the environment of the LIDAR system. The term “scanning the environment of the LIDAR system” includes, in some embodiments, illuminating a field of view (FOV) 125 and/or a portion of FOV 125 of the LIDAR system 102 and/or sensing reflection of light from object/s 120 in FOV 125.

As used herein the term “FOV” and/or “FOV of the LIDAR system” 125, in some embodiments, includes an extent of an observable environment of the LIDAR system in which object/s 120 are detected. In some embodiments, FOV 125 is affected by one or more condition e.g., one or more of: an orientation of the LIDAR system (e.g., is the direction of an optical axis of the LIDAR system); a position of the LIDAR system with respect to the environment (e.g., distance above ground and adjacent topography and obstacles); operational parameter/s of the LIDAR system (e.g., emission power, computational settings, defined angles of operation). FOV 125 of LIDAR system 101 may be defined, for example, by a solid angle (e.g., defined using ϕ, θ angles, in which ϕ and θ are angles defined in perpendicular planes, e.g., with respect to symmetry axes of LIDAR system 101 and/or FOV 125). In some embodiments, FOV 125 is defined within a certain range (e.g., up to 200 m).

In some embodiments, LIDAR system 102 includes a projecting unit 122 which projects light 154 (e.g., laser light). In some embodiments, projecting unit 122 includes at least one light source e.g., laser light source (a solid-state laser, laser diode, a high-power laser). Where, in some embodiments, light source/s include one or more laser light source and/or one or more alternative light source e.g., a light emitting diode (LED)-based light source. In some embodiments, the projecting unit 122 is controllable (e.g., receiving control signal/s from a LIDAR system processor 126) to emit laser light pulses of e.g., known duration and/or timing and/or in a known direction (e.g., controlled by movement of the light source/s or a light deflector).

In some embodiments, reflection/s 156 of the projected light 154 from object/s 120 located within FOV 125 are sensed by a sensing unit 124.

In some embodiments, sensing unit 125 includes one or more light sensor e.g., a laser light sensor. Where, in some embodiments, sensor/s generate an electrical measurement signal related to incident light (e.g., light reflected from object/s 120 within FOV 125) on sensing surface/s of the sensor/s. In some embodiments, the sensor/s generate sensing signals (e.g., with time) related to one or more of: power, frequency, phase, pulse timing, and pulse duration of electromagnetic radiation (e.g., laser light).

In some embodiments, sensor/s of sensing unit 124, include a plurality of detecting elements.

In some embodiments, sensor/s of sensing unit 124 includes light sensors of one or more types where different type sensor/s include different sensitivity and/or size and/or frequencies detected and/or energies detected. In some embodiments, a plurality of different sensors e.g., including different sensor types, are used to increase data acquired (e.g., in comparison to use of one sensor and/or one sensor type).

In some embodiments, sensor signal output from different sensors and/or different type/s of sensor (e.g., SPAD, APD, SiPM, PIN diode, Photodetector), in some embodiments, are combined together e.g., to form a single output.

In one embodiment, the sensor/s include one or more SiPMs (Silicon photomultipliers). Where, in some embodiments, the SiPM/s include an array of avalanche photodiodes (APD), and/or single photon avalanche diodes (SPAD), serving as detection elements e.g., on a common silicon substrate. In some embodiments, distance between SPADs, is between about 10 μm and about 50 μm. In some embodiments, each SPAD, has a recovery time of between about 20 ns and about 100 ns. Alternatively or additionally to use of SiPMs, in some embodiments, non-silicon photomultipliers are used.

In some embodiments, LIDAR system 102 includes a scanning unit 112, which directs light emitted 154 by projecting unit 122 and/or light received 156 by sensing unit 124. In some embodiments, scanning unit 112 includes one or more optical element 112 which e.g., directs incident light 156. In some embodiments, scanning unit 112 includes one or more actuator 118, the movement of which changes directing of emitted light 154 and/or received light 156. Where, in some embodiments, actuator/s 118 are controlled by processor 126.

In some embodiments, scanning the environment of the LIDAR system, includes moving and/or pivoting light deflector 112 to deflect light in differing directions toward different parts of FOV 125.

For example, in some embodiments, during a scanning cycle (e.g., where FOV 125 is measured by emitting a plurality of light pulses over a time period) a position of the deflector 112 and/or position of the light source/s is associated with a portion of FOV 125.

In some embodiments, LIDAR system 102 includes a single scanning unit 112 and/or a single sensing unit 124. In some embodiments, LIDAR system 102 includes more than one scanning unit 112 and/or more than one sensing unit 124 e.g., to provide multiple FOVs 125 e.g., potentially increasing a volume of a combined FOV (e.g., an area of space including the areas of space of the multiple FOVs) and/or a range of angles (e.g., around a vehicle to which the LIDAR system is attached) covered by the combined FOV.

In some embodiments, FOV 125 is an effective FOV where scanning unit 112 (e.g., sequentially) directs light pulses emitted by projecting unit 122 in a plurality of directions to measure different portions of FOV 125 and/or directs (e.g., sequentially) received light pulses from different portions of FOV 125 to sensing unit 124.

In some embodiments, for example, alternatively or additionally to moving scanning unit 112 to emit light in different directions, one or more actuator moves the light source (e.g., projecting unit includes one or more actuator controlled by processor 126) to emit light pulses in different directions to scan FOV 125.

In some embodiments, LIDAR system 102 includes at least one window 148 through which light is projected 154 and/or received 156. In some embodiments, window/s 148 are in housing 152. Where, in some embodiments, window/s 148 include transparent material. In some embodiments, window/s 148 include planar surface/s onto which projected 154 and/or received light 156 are incident. Optionally, in some embodiments, window/s collimate and/or focus incident projected 154 and/or received light 156 e.g., collimate projected light 154 e.g., focus reflected light 156. For example, where, in some embodiments, window 148 includes one or more portion having a curved surface.

In some embodiments, the light source of projecting unit 122 includes one or more vertical-cavity surface-emitting laser (VCSEL). For example, an array of VCSELs. Where, in some embodiments, when the light source includes an array of VCSELs, movement of a deflector and/or other mechanical elements (e.g., deflector 146 e.g., system 102 doesn't include deflector 146) is not used. For example, in some embodiments, light is emitted in different directions by selected activation of VCSELs from different positions in the array. In some embodiments, VCSELs the array are activated individually. In some embodiments, VCSELs the array are activated in groups (e.g., rows).

In some embodiments, the light source includes an external cavity diode laser (ECDL).

In some embodiments, the light source includes a laser diode.

In some embodiments, the light source emits light at a wavelength of about 650-1150 nm or about 800-1000 nm, or about 850-950 nm, or 1300-1600 nm, or lower or higher or intermediate wavelengths or ranges. In an exemplary embodiment, the light source emits light at a wavelength of about 905 nm and/or about 1550 nm.

In some embodiments, LIDAR system 102 includes a scanning unit 112.

In some embodiments, scanning unit 112 includes a light deflector 146. In some embodiments, light deflector 146 includes one or more optical elements which direct received light 156 (e.g., light reflected by object 120/s in FOV 125) towards a sensing unit 124.

In some embodiments, light deflector 146 includes a plurality of optical components, e.g., one or more reflecting element (e.g., a mirror) and/or one or more refracting element (e.g., prism, lens).

In some embodiments, scanning unit 112 includes one or more actuator 118 for movement of one or more portion of light deflector 146. Where, in some embodiments, movement of light deflector 146 directs incident light 156 to different portion/s of sensing unit 124.

For example, in some embodiments, light deflector 146 is controllable (e.g., by control of actuator/s 118 e.g., by processor 126) to one or more of; deflect to a degree α, change deflection angle by Δα, move a component of the light deflector by M millimeters, and change speed in which the deflection angle changes.

In some embodiments, actuator/s 146 pivot light deflector 146 e.g., to scan FOV 125. As used herein the term “pivoting” includes rotating of an object (especially a solid object) about one or more axis of rotation. In one embodiment, pivoting of the light deflector 146, in some embodiments, includes rotation of the light deflector about a fixed axis (e.g., a shaft).

In some embodiments, where other type/s of light deflectors are employed (e.g., non-mechanical-electro-optical beam steering, OPA) do not require any moving components and/or internal movements to change the deflection angles of deflected light. For example, scanning unit lacking actuator/s 118.

It is noted that any discussion relating to moving and/or pivoting a light deflector is also mutatis mutandis applicable to control of movement e.g., via control signals e.g., generated at and/or received by processor/s 119, 126.

In some embodiments, reflections associated with a portion of the FOV 125 corresponding to a position of light deflector 146.

As used herein, the term “instantaneous position of the light deflector” (also referred to as “state of the light deflector”) refers to the location and/or position in space where at least one controlled component of the light deflector 146 is situated at an instantaneous point in time, and/or over a short span of time (e.g., at most 0.5 seconds, or at most 0.1 seconds, or at most 0.01 seconds, or lower or higher or intermediate times). In one embodiment, the instantaneous position of the light deflector, in some embodiments, is gauged with respect to a frame of reference. The frame of reference, in some embodiments, pertains to at least one fixed point in the LIDAR system. Or, for example, the frame of reference, in some embodiments, pertains to at least one fixed point in the scene. In some embodiments, the instantaneous position of the light deflector, include some movement of one or more components of the light deflector (e.g., mirror, prism), usually to a limited degree with respect to the maximal degree of change during a scanning of the FOV.

For example, a scanning of the entire FOV of the LIDAR system, in some embodiments, includes changing deflection of light over a span of 30°, and an instantaneous position of the at least one light deflector, includes angular shifts of the light deflector within 0.05°.

In other embodiments, the term “instantaneous position of the light deflector”, refers to positions of the light deflector during acquisition of light which is processed to provide data for a single point of a point cloud (or another type of 3D model) generated by the LIDAR system. In some embodiments, an instantaneous position of the light deflector, corresponds with a fixed position and/or orientation in which the deflector pauses for a short time during illumination of a particular sub-region of the LIDAR FOV.

In some embodiments, an instantaneous position of the light deflector, corresponds with a certain position/orientation along a scanned range of positions/orientations of the light deflector e.g., that the light deflector passes through as part of a continuous and/or semi-continuous scan of the LIDAR FOV. In some embodiments, the light deflector, during a scanning cycle of the LIDAR FOV, is to be located at a plurality of different instantaneous positions. In some embodiments, during the period of time in which a scanning cycle occurs, the deflector, is moved through a series of different instantaneous positions/orientations. Where the deflector, in some embodiments, reaches each different instantaneous position/orientation at a different time during the scanning cycle.

In some embodiments, navigation system 100, includes one or more processor 126, 119.

For example, in some embodiments, LIDAR system 102 includes processor 126. Where, in some embodiments, processor 126 is housed within housing 152 and/or is hosted by a vehicle to which LIDAR system 102 is attached.

For example, in some embodiments, LIDAR system 102 has connectivity to one or more external processors 119.

For example, where processor 119, in some embodiments is hosted by the cloud.

For example, where processor 119 is a processor of the vehicle to which LIDAR system 102 is attached.

In some embodiments, navigation system 100 includes both an external processor (e.g., hosted by the cloud) and a processor of the vehicle.

In some embodiments, LIDAR system 102 lacks an internal processor 126 and is controlled by external processor 119.

In some embodiments, LIDAR system 102 only includes an internal processor 126.

Processor 126 and/or processor 119, in some embodiments, include a device able to perform a logic operation/s on input/s. Where, in some embodiments, processor/s 118, 126 correspond to physical object/s including electrical circuitry for executing instructions and/or performing logical operation/s. The electrical circuitry, in some embodiments, including one or more integrated circuits (IC), e.g., including one or more of Application-specific integrated circuit/s (ASIC), microchip/s, microcontroller/s, microprocessor/s, all or part of central processing unit/s (CPU), graphics processing unit/s (GPU), digital signal processor/s (DSP), field programmable gate array/s (FPGA).

In some embodiments, system includes one or more memory 128. For example, where memory 128 is a part of LIDAR system 102 (e.g., within housing 152). Alternatively or additionally (e.g., to memory 128), in some embodiments, LIDAR system 102 has connectivity to one or more external memory.

In some embodiments, instructions executed by processor 126, 119, are pre-loaded into memory 128. Where, in some embodiments, memory 128 is integrated with and/or embedded into processor 126.

Memory 128, in some embodiments, comprises one or more of a Random Access Memory (RAM), a Read-Only Memory (ROM), a hard disk, an optical disk, a magnetic medium, a flash memory, a permanent memory, a fixed memory, a volatile memory. In some embodiments, the memory 128 store representative data about one or more objects in the environment (e.g., in one or more measurement FOV) of the LIDAR system.

In some embodiments, navigation system 100 includes one or more user interface 116. Where, in some embodiments, user interface/s 116 display data to user/s (e.g., LIDAR measurement data e.g., navigation instruction/s). Where, in some embodiments, user interface/s 116 receive data from user/s e.g., where a user inputs one or more requirement of navigation system 100 e.g., a destination to be navigated to.

In some embodiments, navigation system 100 includes one or more vehicle control unit 114, which in some embodiments, control movement of a vehicle e.g., to which LIDAR system 102 is attached.

In some embodiments, processor/s 119, 126 generate data and/or control signal/s e.g. which are received vehicle control unit 114 for control of movement of the vehicle.

FIG. 1B is a simplified schematic illustrating use of a LIDAR system 101, according to some embodiments of the disclosure.

In some embodiments, LIDAR system 101 includes one or more feature as illustrated in and/or described regarding LIDAR system 102, FIG. 1A.

In some embodiments, LIDAR system 102 is mounted on a vehicle 158 (e.g., mounted to an external surface of vehicle 104 and/or incorporated into a portion of vehicle 104). Where, in some embodiments, LIDAR system 102 is attached to and/or incorporated into (e.g., at least partially recessed into) a bumper, a fender, a side panel, a spoiler, a roof (e.g., as illustrated in FIG. 1B), a headlight assembly, a taillight assembly, a rear-view mirror assembly, a hood, a trunk.

In some embodiments, LIDAR system 101 has a FOV 125, which is, in some embodiments, a region of space in which LIDAR system 101 acquires measurement by emission of light and sensing of reflection/s of the emitted light. In some embodiments, FOV 125 includes one or more feature as described and/or illustrated regarding FOV 125 FIG. 1A.

FOV 125, in some embodiments, extends in a direction generally forwards of vehicle 104 (e.g., in a direction of movement of vehicle 104 and/or extending from vehicle 104 in a direction of a vector connecting the vehicle back to the vehicle front). In some embodiments, FOV 125 extends at an angle θ in a first direction (e.g. horizontally) around vehicle 104. Where θ, in some embodiments, is 60-360°, or 70-180°, or 80-120°, or lower or higher or intermediate ranges or angles. In some embodiments, FOV 125 extends at an angle ϕ in a second direction (e.g. vertically) around vehicle 104. Where ϕ, in some embodiments, is 60-360°, or 70-180°, or 80-120°, or lower or higher or intermediate ranges or angles.

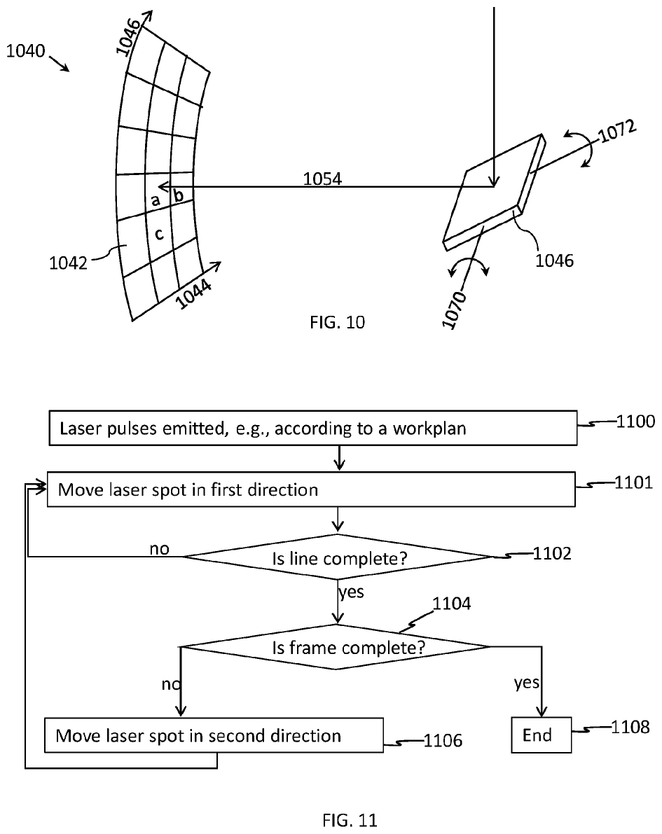

In some embodiments, FOV 125 is provided by a single scanning unit. Alternatively, in some embodiments, FOV 125 is provided a plurality of scanning units, for example, having FOVs extending in different directions from vehicle 104. In some embodiments, FOV 125 is extended by using multiple LIDAR systems 101. In some embodiments, a single scanning unit extends its FOV by moving, for example, by rotating about one or more axes (e.g. referring to FIG. 10 axes 1070, 1072).

In some embodiments, an extent 150 of FOV 125, extending away from the vehicle in a horizontal direction and/or a direction of a central longitudinal axis 164 of vehicle 104 is 50-500 m, or 100-300, or up to 200 m, or lower or higher or intermediate distances or ranges.

In some embodiments, a maximal extent 151 of FOV 125, in a vertical direction and/or a direction perpendicular to central longitudinal axis of 164 vehicle 104 is 10-50 m, or lower, or higher, or intermediate, distances, or ranges.

### Exemplary Offset Pixel Grids

FIGS. 2A-C are simplified schematics of a LIDAR pixel grid 240, according to some embodiments of the disclosure.

FIGS. 2A-C illustrate a LIDAR pixel grid 240 (or portions 240 of pixel grids) where layout of grid 240 corresponds to a system set up where a spatial arrangement of pixels 242 of the grids 240 relate to real space areas, also termed “field of view (FOV) pixels”, in which LIDAR light pulses are emitted for acquisition of data. Where each grid pixel, in some embodiments, corresponds to direction of a pulse of light emitted from an illumination source of a LIDAR system (e.g., system 102 FIG. 1A, system 101 FIG. 1B). In some embodiments, each FOV pixel is illuminated in a sequence that is controlled by the illumination source emission timing, and a pointing direction e.g., as controlled by a LIDAR system scanning mechanism.

Although the term “grid pixel” refers to a data construct and the term “FOV pixel” refers to a real space, in some portions of this document, a generic term “pixel” is used and should be understood to refer to either or both of the data measurement of the real space and the real space being measured itself.

In some embodiments, FOV pixels 240 cover a continuous space, with, for example, negligible distance between FOV pixels (e.g. less 0.0005-0.005 degrees, the angle being an angle difference between direction of emission of pixels which corresponds to pixel size but does not vary with distance) in one or both directions. For example, at least in one direction e.g. horizontally.

FIGS. 2A-B illustrate an aligned (also termed “non-offset”) LIDAR grid 240 where pixels 242 of grid 240 have a same size, are aligned in both a first direction 244 and a second direction 246.

Although it should be understood that grid 240 is orientable in different directions with respect to a real life scene being imaged, in some embodiments, first and second directions 244, 246, are aligned with horizontal and vertical directions of the scene. At times in this document, for simplicity of discussion, grid directions are referred to using terms “horizontal” and “vertical” and the corresponding terms “width” and “height” for pixel dimensions where the terms should be understood to encompass such an orientation, although orientation of the grid directions with respect to the real world are, in some embodiments, adjustable.

FIGS. 2A-C, illustrate different measurement scenarios where objects 232a-c of different size and/or position are measured. Where shaded grid pixels, also herein termed “activated” pixels indicate that, within a time duration after a LIDAR pulse of light is emitted for a FOV pixel, a corresponding reflected pulse of light is received and/or detected (e.g., by sensing unit 124 FIG. 1A).

Referring now to FIG. 2A, object 232a has a sub-pixel vertical dimension, where an object height 234a is less than a FOV pixel height 246. Where, when describing interaction between grid pixel dimensions and object dimensions, reference is to an effective size of the pixels (size of FOV pixels) at a position of the reflecting surface of the object. For example, referring back to FIG. 1B, where FOV 125 size (and correspondingly, in some embodiments, FOV pixel size) increases with distance 150 from LIDAR system 101 FIG. 1B.

For example, in an exemplary embodiment:

| Distance (m) | Pixel Height (cm) |
|---|---|
| 150 | 13.09 |
| 100 | 8.73 |
| 50 | 4.36 |
| 20 | 1.75 |
| 10 | 0.87 |

In some embodiments, intensity of a measured reflection is associated with (e.g., proportional to) a reflectivity of the reflecting object and with a proportion of the real space area associated with the FOV pixel occupied by the object. In some embodiments, a grid pixel is considered activated, when the intensity of the reflection measurement is above a threshold, herein termed an “activation” threshold.

Where, optionally, in some embodiments, different intensity thresholds are used for different delay times of arrival of an emitted light pulse (e.g., corresponding to different distances from the LIDAR system to the reflecting object).

In FIG. 2A, object 234a is positioned with respect to grid 240, within a row of FOV pixels, in which case, in some embodiments, vertical oversizing of the data object with respect to real object 232a, for a FOV pixel for which the object extends horizontally along the whole FOV pixel, is up to a height of the FOV pixel less a height of the object which produces the activation threshold intensity:

$${h}_{o} = {p}_{h} - {h}_{a} \qquad Equation 1$$

Where hₒ is the maximum potential oversizing height, pₕ is pixel height, and hₐ is a pixel height associated with activation threshold intensity.

Referring now to FIG. 2B, an object 232b having a same vertical dimension 234b as object 232a in FIG. 2A appears on grid 240 positioned at horizonal junction between pixel rows, vertically overlapping two horizonal FOV pixel rows, resulting in 6 activated pixels 230a and an associated height 236b of the object as indicated by external pixel boundaries. The difference in positioning of object 232b with respect to grid 240 increases error in determining object 232b dimension/s using outer boundary/ies of activated pixels. In embodiments where the real object is close in size to a size requiring breaking and/or evasive action of the vehicle, the increased potential oversizing is potentially associated with false positive indications of need for breaking and/or evasive action.

Where, for the scenario illustrated in FIG. 2B a maximum potential oversizing is:

$${h}_{o} = 2 {p}_{h} - 2 {h}_{a} \qquad Equation 2$$

Referring now to FIG. 2C, an object 232c has a larger vertical dimension 234c than that of objects 232a-b in FIG. 2A-B respectively. Where object 232c vertical dimension 234c is larger than a pixel height 228, and the object extending over 3 rows of pixels. FIG. 2C, in some embodiments, illustrates a worst case scenario in terms of correctly identifying whether an object is over-drivable, where the object is near to a maximal over-drivable height, and where the object extends partially vertically into two rows of pixels, resulting in oversizing of the object height associated using borders of activated pixels occurring at two pixels.

Numerical examples will now be described. Where grid illumination is of 0.05 deg×0.1 deg optical resolution and the reflecting object is at a distance of 100 m. Each pixel illuminates a region with dimensions 244 by 266. For example, with a 0.05 deg×0.1 deg optical resolution, at a distance of 100 m 244 is ˜17.5 cm, and 266 is ˜8.7 cm. Therefore, referring to FIG. 2A, using outer borders of activated pixels 230a height of object 232a is determined to be ˜8.7 cm.

Referring now to FIG. 2B, using outer borders of activated pixels 230b, height of object 232b is determined to be ˜17.5 cm.

In a situation where real objects 232a, 232b have real heights 234a, 234b of 3 cm, considered to be over-drivable where a threshold for over-drivability, in some embodiments, is about 14 cm. In this case, the scenario of FIG. 2A results in a correct categorization of the obstacle being over-drivable, whereas, for the same grid, and the same object, but different alignments of the grid with the object, as FIGS. 2A-B illustrate, the object height is now determined not to be over-drivable resulting in a false positive indication that the vehicle needs to break and/or change route.

Referring now to FIG. 2C, object 232c in the scene 802 has a height 234c. For example, the real height 234c of obstacle 232c may be 12 cm, i.e. a ‘small obstacle’. Since object 232c overlaps 3 rows of pixels in this example, height 236c as determined by outer borders of the activated pixels 230c is of three pixels. In this example, height 236c may be 26 cm. Although the height of the detected obstacle 232c is ˜12 cm tall, since the detection activates the entire pixel and overlaps 3 pixels, the detected height is ˜26 cm, predicting a ‘huge obstacle’. This may trigger an unnecessary braking event.

FIGS. 3A-C are simplified schematics of a LIDAR pixel grid 340, according to some embodiments of the disclosure.

In some embodiments, at least a portion of pixel grid 340 includes pixel/s which are offset (also herein termed “shifted” or “staggered”, and/or the pixel grid as a “skewed” grid) from each other.

Where, in some embodiments, for one or more pixel, adjacent pixels in one direction are offset by a distance in the orthogonal direction. Where the distance is less than that of a pixel dimension in that direction.

Where, for example, alternating columns of grid 340 are offset vertically by offset 348 which is a portion (in FIG. 3A about 50%) of height 328. For example, where alternate columns of the grid are shifted by a distance 348 with respect to other columns.

For example, referring to FIG. 3A, where columns C2 and C4 are shifted by a distance 348 in direction 346 with respect to columns C1, C3, and C5. Where, in some embodiments, the offset distance 248 is 10-50% of pixel dimension 328.

In some embodiments, both rows and columns of the grid may be shifted, the rectangular grid then, in some embodiments, having empty non-pixel spaces.

In some embodiments, FIG. 3A illustrates a pixel grid 340 with pixels having same dimensions as those of FIGS. 2A-C, where height 328 and width 326 correspond to height 228 and width 226 respectively of FIGS. 2A-C.

In some embodiments, FOV pixels 340 illuminate a continuous volume, with, for example, negligible distance between FOV pixels. For example, at least in one direction e.g. horizontally.

In some embodiments, FIG. 3A illustrates an object 332a having a same dimension (e.g., height) 334a as objects 232a-b FIGS. 2A-B respectively.

FIG. 3A illustrates grid 340 with a geometric pattern of activated pixels 301, 302, 303, 304 associated with object 332a. Where the activated pixels 330a associated with object 332a include two single pixels 301, 304 each single pixel adjacent to two pixels 302, 303 in an adjacent, offset column.

In some embodiments, for example, according to feature/s of FIG. 4, it is assumed that inner edge pixels 301, 304 of activated pixel group 330a correspond to dimensions of the object being measured and/or correspond to a ‘real’ space containing the real object 332a. And/or, externally extending portions of the offset pixels 302, 303 of groups 330a are suspected not to correspond to a real space containing real object 332a. For example, referring to FIG. 3A where object 332a, according to these assumption/s, is determined to have a height 336b. Where, using a method (e.g., such as described in FIG. 4) a maximum oversizing of the measured object with respect to the real object is potentially reduced. For example, referring back to FIGS. 2A-B, oversizing is potentially reduced to that of FIG. 2A, regardless of position of the object with respect to horizontal pixel boundaries.

Returning to numerical examples, in the case of FIG. 3A, and using a same pixel size as used in numerical examples for FIGS. 2A-C, height 336b determined for object 332a is the height of a single pixel, ˜8.7 cm at 100 m for a given resolution of 0.05 degrees.

FIG. 3B illustrates a geometric pattern of activated pixels 330b, corresponding to a real object 334b where two pixels are activated in alternating rows, and three pixels activated in others. Using the method described in FIG. 4, a height 334b of object 332b is determined as a height 336b of two pixels, resulting in much lower oversizing of the object e.g., in comparison to that illustrated and/or described regarding FIG. 2C if height 234c is the same as height 334b.

FIG. 3C illustrates a scenario where the same object 332a as that of FIG. 3A is measured using grid 340, but alignment of object 332a with grid 340 results in a different geometric pattern of activated pixels 330c. Where, for two columns of the grid, two pixels are activated, and for one column, one pixel is activated. In contrast with FIG. 3A where for two columns, two columns a single pixel is activated and for a single column, a single pixel is activated.

Although, generally, in this document, shifting is illustrated and/or discussed for alternate columns, in some embodiments, shifting is for fewer or larger proportions of the pixel grid, for example, every column being shifted from adjacent columns (e.g., see FIGS. 13A-B), for example, every third column being shifted, or every fourth column or lower or higher or intermediate numbers of columns.

FIG. 3D is a simplified schematic of a LIDAR pixel grid 341, according to some embodiments of the disclosure.

FIG. 3D illustrates an embodiment where every third column, C3, and C6 are shifted (by a same shift dimension 349) with respect to the other columns C1, C2, C4, and C5.

In some embodiments, within pixel grids, shift dimensions are the same e.g. referring to FIG. 3C where dimension 347 is equal to dimension 348, e.g. referring to FIG. 13A where dimension 1348 is equal to dimensions 1347, 1349. However, in some embodiments, offsets within a single grid have different sizes:

FIG. 3E is a simplified schematic of a LIDAR pixel grid 343, according to some embodiments of the disclosure.

FIG. 3E illustrates an embodiment where offsets 347e, 348e within the grid have different sizes.

### Exemplary Determining of Object Boundary/ies Using Offset Pixel Grids

FIG. 4 is a method of processing LIDAR measurement data, according to some embodiments of the disclosure.

In some embodiments, the method of FIG. 4 is a computer implemented method e.g. implemented by one or more processor.

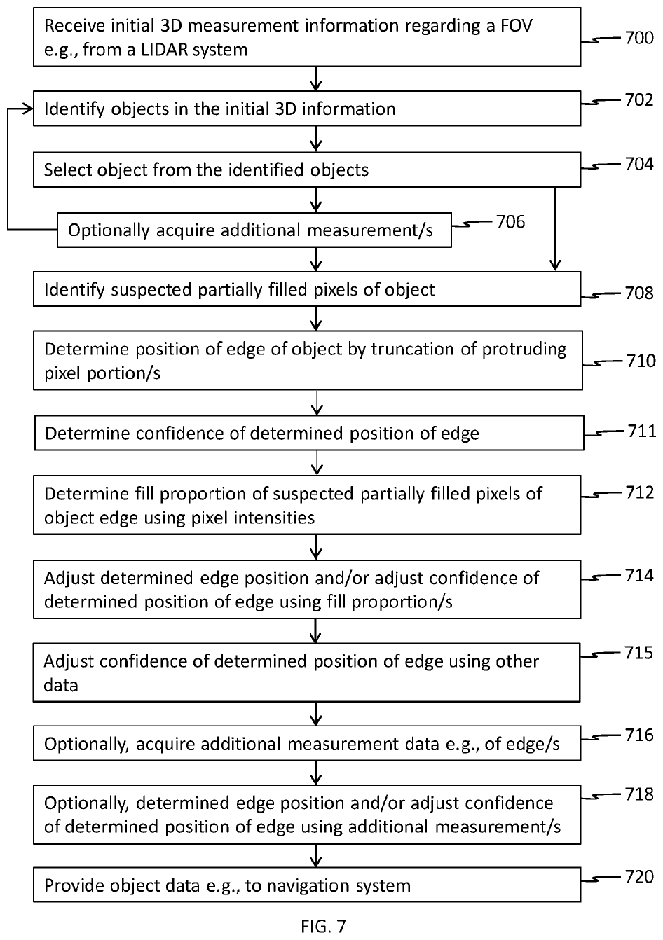

At 400, object pixel data is received. For example, where the pixel data includes data regarding a cluster of activated pixels. Where, in some embodiments, the cluster has been identified and/or categorized as corresponding to an object (e.g. step 702 FIG. 7). In some embodiments, at least a portion of the cluster includes offset pixels.

In some embodiments, at least a portion of at least one edge of the object pixel cluster includes offset pixels the edge not being straight.

At 402, in some embodiments, suspected partially filled pixels are identified. Where partial filling, in some embodiments, corresponds to the object partially filling a real space corresponding to the pixel.

In some embodiments, suspected partially filled pixels include inner edge pixels of the object. Inner edge pixels defined, for example, as being edge pixels recessed from other (outer) edge pixels e.g. the recessing associated with offset of an offset pixel grid.

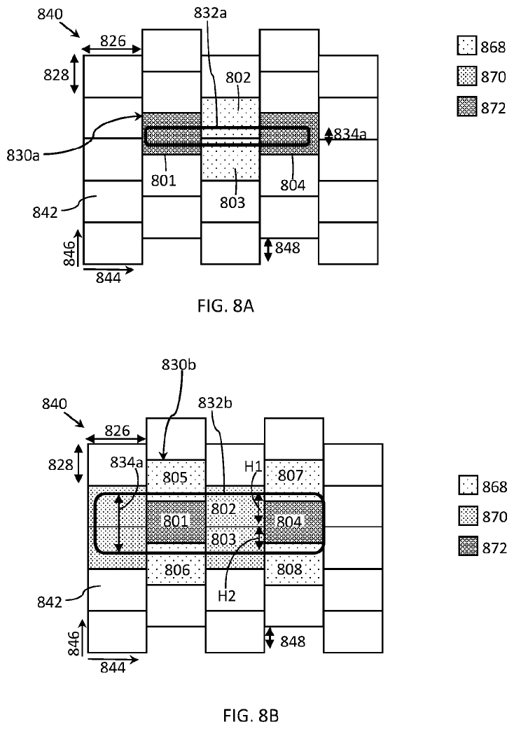

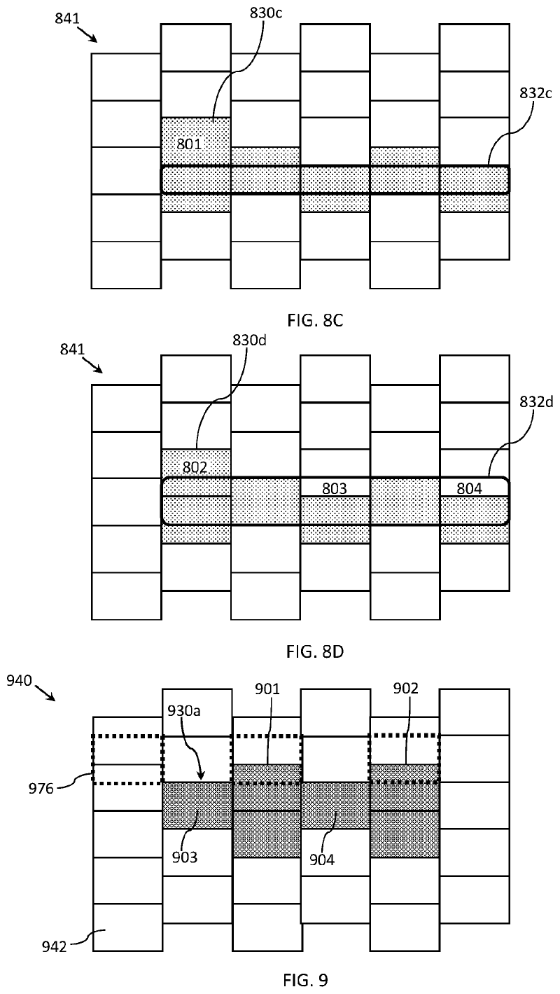

For example, referring back to FIG. 3A where pixels 301 and 304 are inner edge pixels and pixel 302 is an outer edge pixel. For example, referring to FIG. 8B, pixel 802 is an inner edge pixel and pixels 805, 807 are outer edge pixels.

In some embodiments, suspected partially filled pixels are identified using pattern matching. For example, by identifying “t-shaped” activated pixel pattern/s at an edge of an object. The t-shape, for example, illustrated in FIG. 3A and FIG. 3B. For example, by identifying “h-shaped” activated pixel pattern/s at an edge of the object. The h-shape, for example, illustrated in FIG. 3C and FIG. 8B.

At 404, in some embodiments, an outer edge of the object is determined by truncating one or more suspected partially filled pixel. For example, to determine dimension/s of the object to sub-pixel resolution.

Where, in some embodiments, for one or more offset outer edge of the pixel object, it is assumed that the real object does not extend to the offset portion of the outer pixel/s of the edge, and a position of an edge of the object is determined to be at (or within) an edge of the inner pixels of the offset edge.

Optionally, step 404 is employed only once certain conditions are met. For example, in some embodiments, a minimum number of edge pixels are required.

Optionally, in some embodiments, a confidence level as to positioning of the edge at a boundary is determined.

### Exemplary Determining of Object Boundary/ies Using Pixel Intensities

FIGS. 5A-C are simplified schematics of a LIDAR pixel grid 540, according to some embodiments of the disclosure.

Where, in some embodiments, pixel grid 540 includes one or more feature as illustrated in and/or described regarding pixel grids 240 FIGS. 2A-C. Where activated pixels 530a, 530b, 530c are indicated by shading. In some embodiments, data in grid 540 includes, e.g. for each activated pixel, intensity information for detected light. Where, the higher the intensity the darker the shading of pixels in FIGS. 5A-C e.g. where shading 568 indicates low intensity, shading 570 indicates medium intensity, and shading 572 indicates high intensity.

Without wanting to be bound by theory, it is theorized that when a FOV pixel is partially filled by a reflecting object, one or more measurement feature of the signal as herein termed signal “strength” and/or “intensity” of a detection signal for the pixel depends on the reflectivity of the target, and the proportion (e.g., percentage) of the pixel filled by the object. Given that the object has uniform reflectivity, and where illumination power is the same for each pixel. Where exemplary measurement feature/s including one or more of peak power of the signal, mean power of the signal, and energy of the signal.

Where the proportion of the pixel “filled” by the object is also termed the proportion (e.g., percentage) “overlap” of the object with the pixel.

Since (it is theorized) that the measured intensity depends on both the proportion overlap and reflectivity of the object, a fully overlapping pixel reflected from a low reflective target, in some embodiments, results in a signal strength similar to a partially overlapping pixel of a high reflective target. However, for an object with uniform reflectivity, intensity for a pixel will increase with the proportion of the overlap.

In some embodiments, it is assumed that the object has sufficiently uniform reflectivity across a surface that pixel intensities are associated with a proportion of overlap of the object with the pixel. Where this situation is illustrated in FIGS. 5A-C where darkness of shading (corresponding to intensity) of pixels of the object pixel data is associated with the proportion of the pixel filled by the object.

Referring now to FIG. 5A which illustrates an object 532a which extends vertically into three rows, partially into top (of the object pixel cluster) and bottom (of the object pixel cluster) border rows and covering a central row. In some embodiments, those pixels entirely filled by the object are used to determine (e.g., assuming uniform reflectivity of the object) a proportion of the object present in an edge pixel e.g., to provide dimension/s of the object e.g., to a resolution lower than that provided by pixel dimensions.

For example, referring now to FIG. 5B, where an object 532b is positioned extending across a horizontal border between two pixel rows. Reflection of light from object 532b, resulting in activating both pixels above and below the border. In some embodiments, as object 532b extends into a smaller portion of the upper row than the lower row, corresponding lower intensities are measured for the upper row than for the lower row (e.g., as illustrated by lighter shading in the upper row than the lower row of activated pixels).

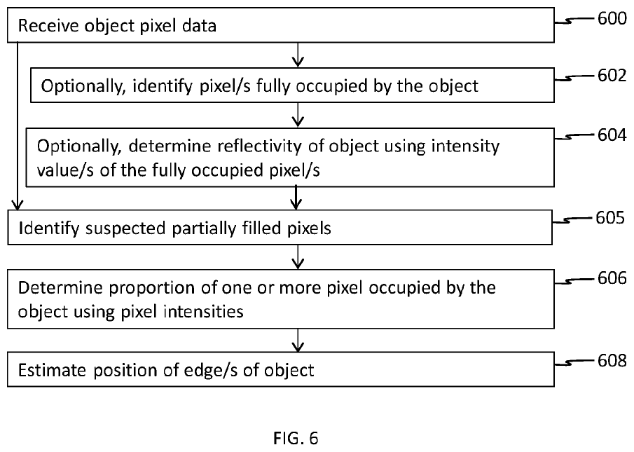

FIG. 6 is a method of determining an object boundary in LIDAR pixel data, according to some embodiments of the disclosure.

In some embodiments, the method of FIG. 6 is a computer implemented method e.g. implemented by one or more processor.

At 600, in some embodiments, object pixel data is received, e.g., the receiving including one or more feature as illustrated in and/or described regarding step 400 FIG. 4.

At 602, optionally, in some embodiments, pixels corresponding to a space filled (or mostly filled, herein termed “filled pixels”) by the reflecting object are identified. For example, referring to FIG. 5A, in some embodiments, central pixels 572 having higher intensity (more darkly shaded) are identified. Where, in some embodiments, filled pixels are identified by intensity (e.g. relative to other pixels of the object cluster) and/or by position (e.g. relative to other pixels of the object cluster).

For example, in some embodiments, a confidence level as to whether a pixel is partially filled or not is generated e.g. based on geometrical position with respect to other pixel/s of the object and/or intensity with respect to other pixel/s of the object.

In some embodiments, suspected partially filled pixels include those having lower intensity than object data pixels considered to be central and/or fully filled. Where, in some embodiments, lower intensity pixels are those having an intensity lower than a threshold. The threshold being, in some embodiments, determined by intensity values of pixel/s considered to be central (e.g. a proportion of an average intensity of central pixels).

At 604, in some embodiments, the pixels identified in step 702 are used to determine a value of reflectivity for object. Where, in some embodiments, reflectivity is determined from intensities of filled pixels e.g. as an average of the intensities thereof.

At 605, in some embodiments, suspected partially filled pixels are identified, for example, as those having lower intensity e.g. than a threshold and/or an average object pixel intensity and/or than central pixels identified in step 602.

At 606, optionally, in some embodiments, a proportion of one or more partially filled pixel is determined using a value of reflectivity (e.g., that determined in step 704). Where, in some embodiments, this procedure is performed for edge pixel/s of the object.

At 608, in some embodiments, object dimension/s (e.g., object height) are determined and/or corrected using the proportion of occupation of the object in edge pixel/s. For example to increase accuracy of a position of the border and/or of a dimension of the object and/or a confidence in position of the edge. For example, referring to FIG. 5A where intensity of central pixels 572 is used to reduce a height of object 532a as provided by the grid from height 536a indicated by boundaries of activated pixels 530a.

For example, where it is determined that intensity measured in an edge pixel indicates that the pixel is 10% occupied the object boundary is placed enclosing 10% of the pixel.

Where, in some embodiments, a boundary line of the object crossing a pixel is positioned between external edge/s of the pixel and a center of the object. In some embodiments, the boundary line is positioned parallel to a direction of rows of the grid (or columns). Alternatively, in some embodiments, the boundary line/s are not restricted to parallel to pixel grid direction/s, for example, as illustrated in FIG. 5C where boundary 532 encompasses a volume closest to central pixel/s of the object cluster which corresponds to the relative intensity of the pixel in question.

### Exemplary Detailed Method

FIG. 7 is a method of processing LIDAR pixel data, according to some embodiments of the disclosure.

In some embodiments, the method of FIG. 7 is a computer implemented method e.g. implemented by one or more processor.

At 700, in some embodiments, initial 3D measurement information regarding a field of view (FOV) is received e.g., from a LIDAR system (e.g., system 102 FIG. 1A, system 101 FIG. 1B).

In some embodiments, a pixel grid is received, the grid including data for each pixel of the grid, herein termed “pixel data”. Where, in some embodiments, a point cloud of data points is received, for example, each point of the point cloud corresponding to a pixel of a pixel grid. In some embodiments, the pixel data includes, e.g. for each pixel of the grid, whether the pixel was activated e.g., whether a reflected light pulse was detected in under a threshold time after emission of the light and/or at above a threshold intensity.

In some embodiments, the initial measurement information is acquired using a non-offset grid (e.g., grid FIGS. 2A-C). Alternatively, in some embodiments, the initial measurement information is acquired with an offset grid (e.g., grid 304 FIGS. 3A-B e.g., grid 1340 FIGS. 13A-B).

Optionally, in some embodiments, pixel data includes a measure of intensity related to reflectivity of the object reflecting the pulse of laser light (e.g., in addition to whether the pixel is activated and/or time of receipt of the reflected pulse from which distance to the object is determined).

At 702, in some embodiments, one or more object is identified in the initial 3D information. Where, in some embodiments, objects are identified as clusters of data points (pixels) having a same or about the same distance from the LIDAR system.

At 704, in some embodiments, a portion of identified object/s are selected.

For example, object/s fulfilling one or more size and/or shape characteristic. For example, those objects having a height indicated by dimensions of the object pixel cluster as near to a height requiring an action (e.g. breaking or route-changing). For example, object/s having a surface that is parallel or near parallel with the scanning direction of a LIDAR system scanning it.

For example, objects which are potentially over-drivable (herein termed “low in-path objects”) are identified. Where such objects, for example, include height and/or position features within given ranges. In some embodiments, potentially over-drivable objects are also within a range of distances of the LIDAR system. For example, those which are too far away are ignored e.g., potentially to be assessed later. For example, those which are too close not being evaluated, as evasive action of the vehicle has already been deemed necessary.

In some embodiments, objects at a distance of greater than 60 meters, or greater than 50-100 m, or lower or higher or intermediate distances or ranges from the LIDAR system are selected.

In some embodiments, closer to the LIDAR, a single pixel error in height of an object does not result in significant height errors e.g., where oversizing is less likely to cause mischaracterization of over-drivability of an object. However, at greater distances, in some embodiments, each pixel potentially contributes a larger error (which increases with distance), for example, a potential error of more than 5 cm, or more than 8 cm, or more than 10 cm, or lower or higher or intermediate distances, e.g., potentially causing false identifications of ‘large’ or ‘huge’ objects, and unnecessary braking events.

At 706, optionally, in some embodiments, additional LIDAR measurements are acquired e.g., for identified low in-path objects.

For example, where the initial 3D measurement information is acquired using a first grid e.g. where rows and/or columns of the grid are aligned (e.g., grid FIGS. 2A-C), in some embodiments, additional data e.g., at a region of the identified low in-path objects is acquired, for example, with an offset grid (e.g., grid 304 FIGS. 3A-C e.g., grid 1304 FIGS. 13A-B).

Optionally, in some embodiments, additional pixel data is acquired e.g., at a region of object edge/s. For example, according to one or more feature as illustrated in and/or described regarding FIG. 9.

In some embodiments, the additional measurements are used to augment object data previously identified in step 502 and/or initial measurement information received at step 500 (where the additional measurement information is used with the initial measurement information in step 502).

At 708, in some embodiments, suspected partially filled pixels of the object pixel data are identified. For example, according to one or more feature of step 402 FIG. 4. For example, according to one or more feature of step 605 FIG. 6.

In an exemplary embodiment, partially filled pixels are identified using their position in an object pixel cluster (e.g. as being at an edge of an object) and using their intensity.

For example, where, in some embodiments, those pixels having lower intensity are identified and then their position is evaluated.

At 710, in some embodiments, using object pixel data, for one or more object, a position of one or more edge of the object is determined e.g., according to one or more feature as illustrated in and/or described regarding step 404 FIG. 4.

At 711, in some embodiments, a confidence level of the determined edge position/s is determined. For example, where, the larger a number of pixels consistently indicating a same edge, the higher the confidence indicated for positioning of the edge. For example, referring to FIG. 3A and FIG. 3C, in FIG. 3A the upper edge of the object cluster 330a has two inner pixels 301, 304 and a single outer pixel 302 whereas FIG. 3C has two outer pixels and a single inner pixel for the upper edge of cluster 330c. FIG. 3A having a higher ratio pixels indicating a lower height than FIG. 3C, FIG. 3C correspondingly, in some embodiments, having a lower confidence level for positioning of the edge at an outer border of the inner pixel/s of the edge.

At 712, in some embodiments, a fill proportion for suspected partially filled pixels is determined e.g. using pixel intensity data e.g., according to one or more feature of steps 602-606 FIG. 6 and/or using geometry of the pixel object data e.g. using the pixel offset to determine fill proportion.

At 714, in some embodiments, the position of the edge is adjusted and/or the confidence level is adjusted using the fill proportions determined at step 712. For example, where relative intensities of pixels are used to increase confidence in the assumption that a pixel is a partial pixel e.g. as discussed in the description of FIG. 8B.

At 715, in some embodiments, other data is used to adjust the confidence level. For example, in some embodiments, one or more feature of measurement signals e.g. of reflected pulses from the object (e.g. with respect to the emitted pulse shape) is used. The features, for example, including one or more of pulse height, pulse width, pulse shape, e.g. one or more feature of a derivative and/or integral of the pulse intensity with time signal. For example, where, in some embodiments, a surface angle (also termed grazing angle) of the object, the angle of the portion of the object surface at the pixel, with respect to a direction of the light beam is determined from the sensed reflected pulse shape (e.g. shape of the signal intensity with time measurement).

At 716, optionally, in some embodiments, additional measurement data is acquired. For example, according to one or more feature as illustrated in and/or described regarding FIG. 9.

At 718, optionally, in some embodiments, object edge position/s are verified and/or corrected, using the additional pixel data acquired at step 716.

At 720, in some embodiments, determined object edge position/s are provided to a navigation system. Optionally, along with the confidence level of the determined object edge position.

In some embodiments, one or more step of the method of FIG. 7 is implemented by a machine learning (ML) model (e.g., a neural network). For example, where the ML model is used to determine edge position/s of objects. For example, in some embodiments, the ML model is trained using sets of pixel object data for known dimension objects. Then, the trained ML model provides, upon input of object pixel data, edge position/s for the object. Where, in some embodiments, object pixel data includes one or more of position within a grid of the object pixels (e.g. geometry of the object), pixel intensity, reflectivities (e.g. as determined from intensity data of object pixels), and grazing angle.

FIGS. 8A-B are simplified schematics of a LIDAR pixel grid 840, according to some embodiments of the disclosure.

In some embodiments, grid 840 includes one or more feature as illustrated in and/or described regarding grid 340 FIGS. 3A-C.

FIG. 8A illustrates grid 840 with a geometric pattern of activated pixels 830a associated with an object 832a. A geometry with a non-uniform height is detected, with two pixels 802, 803 activated in one column, and in neighbor (also herein termed “adjacent”) columns a single pixel 801, 804 is activated.

In some embodiments, for example, according to feature/s described regarding step 402 FIG. 4, an assumption that inner edge pixel/s 801, 804 of the activated pixel group 830a spatially contain the real object 832a along with use of intensity measurements of the object are used to determine edge/s of object 832a. Where, in some embodiments, relative intensity values are used to increase confidence in the assumption that pixels 802, 803 are partially filled. For example, based on a ratio of intensity of pixels 802, 803 to filled pixels, e.g. where a sum of intensities of pixels 802, 803 is about equal to that of the intensity of 801 and/or 804.

Referring now to FIG. 8B, activated pixels 830b (801-808) associated with real object 832b include three pixels 805, 801, 806 in at least one column.

Pixels 801 and 804 are activated with a high reflectivity value 872 (since spot overlap is 100%), and pixels 805, 806, 807, 808 are activated with low reflectivity 868 since the spot overlap is less than 50%. Pixels 802, 803 have medium reflectivity measurements 870. In some embodiments, relative reflectivity measurements used to determine the proportion (e.g., percentage) overlap in each pixel in each column, and determine a more precise height e.g., than that delineated by pixel edges. For example,

Where the real height of the real object, H, in some embodiments, is determined according to Equation 3 below:

$$Hr = H 1 + H 2 = H ( \frac{Ref 2}{Ref 1} + \frac{Ref 3}{Ref 1} ) \qquad Equation 3$$

Where the real height of the real object is Hr, H is pixel height, Ref2 is the reflectivity of pixel 802, Ref3 is the reflectivity of pixel 803, and Ref1 is the reflectivity of pixel 801.

In this example, it is assumed that the reflectivity of object 832b is uniform, that the grazing angle is about 90 degrees, and that pixel height 828 is uniform. Additionally, in some embodiments, certain points are filtered out of the calculation (e.g., saturated points with reflectivity higher than the upper limit of the reflectivity detection range). Relative reflectivities may be used to obtain sub-pixel accuracy for height.

FIGS. 8C-D are simplified schematics of a pixel grid 841, according to some embodiments of the disclosure.

FIGS. 8C-D illustrate exemplary sensing scenarios where activated pixels 830c, 830d correspond to objects 832c, 832d respectively.

Referring to FIG. 8C, pixel 801 is a measurement which does not provide a same object border as the rest of activated pixels 830c. In some embodiments, such an activated pixel 801 is ignored as noise and/or measurement error. In some embodiments, such pixels 801 reduce a confidence level in the determined object border.

Referring to FIG. 8D, a situation where object partially overlaps pixels 803, 804 but does not activate them e.g. the intensity of the measurement for these pixels falling below a threshold and/or associated with noise. Whereas pixel 802, at a same height, is activated, the discrepancy, in some embodiments, associated with noise and/or non-uniform reflectivity of the object. In some embodiments, such an identified discrepancy between pixel 802 and pixels 803, 804 reduces a confidence level in determined position of a border of the object.

### Exemplary Additional Data Acquisition

FIG. 9 is a simplified schematics of a pixel grid, 940 according to some embodiments of the disclosure.

In some embodiments, once an edge of a cluster of activated pixels 930a corresponding to an object is identified, in some embodiments, additional data is acquired regarding the edge.

Where, in some embodiments, for example, as illustrated by dashed line pixels 976 in FIG. 9, additional pixels are acquired (e.g. an additional row), where, in some embodiments, the additional pixels extend the overhanging portions of offset pixels at a border of outer edge pixel/s 901, 902. In some embodiments, additional pixels 976 increase confidence in positioning of a border of the real object at the outer edge of inner pixels 903, 904. For example, if additional (dashed line) pixels 976 are not activated, in some embodiments, a confidence in the object height determined from pixels 903 and 904 is increased.

In some embodiments, acquiring of additional pixels 976 includes controlling acquisition using velocity of the vehicle and time between acquisition of the initial data and of the additional pixels e.g. to control a scanning unit and an illumination unit to acquire additional pixels at desired positions in the grid.

### Exemplary Offset Pixel Grids

FIG. 10 is a simplified schematic illustrating control of pixel position, according to some embodiments of the disclosure.

In FIG. 10 a pixel grid 1040 having a plurality of FOV pixels 1042 (corresponding to real space pixels) is illustrated. Where LIDAR light illumination 1054 is directed by a deflector 1046 each beam of illumination, in some embodiments, relating to a pixel 1042 region of space.

In some embodiments, orientation of deflector 1046 is controlled to position pixels 1042 in grid 1040. Where, in some embodiments, rotation of deflector 1046 about axis 1072 rotates beam 1054 in a first direction 1044 and rotation about axis 1070 moves pulse 1054 in a second direction 1046.

Although, some aspects of this disclosure are employable regardless of order of acquisition of pixels and/or movement/s of system elements for direction of pulses (e.g., movements of deflector 1054) and/or element set up for acquiring data within pixel grids, exemplary embodiments are herein described for acquisition of staggered grids (e.g., grids having offset pixel/s).

FIG. 11 is a LIDAR scanning method, according to some embodiments of the disclosure;

At 1100, in some embodiments, a laser pulses are emitted e.g., according to an illumination workplan. Where, in some embodiments, after a pulse is emitted, the pulse having a pulse duration, a duration of time passes in which no pulses are emitted e.g., prior to emission of a subsequent pulse. In some embodiments, element/s of a light source (e.g. light source 112 FIG. 1A) move to change direction of the laser pulses (e.g. referring to FIG. 10, by rotation of at least one deflector 1046 about one or more axis 1070, 1072). In some embodiments, the light source element/s move continuously emitting pulses during movement. Alternatively, in some embodiments, movement occurs during times in between emissions e.g., where laser pulse emission is not occurring.

At 1101, in some embodiments, the laser beam is deflected along a first scan line, in a first direction, until the scan line is completed.

At 1106, once the scan line is complete (at step 1102), but before a data frame (also termed “grid”) is complete (at step 1104) the laser spot is deflected in a second direction. For example, in preparation for scanning an additional line of the grid.

In some embodiments, non-offset grids e.g., as illustrated in FIGS. 2A-C, are produced by, during step 1101, movements between pulse emissions correspond to a pixel size in the first direction, positioning the pixels of the line next to each other (e.g., without spaces). Where, at step 1106 movement is of a pixel size in the second direction.

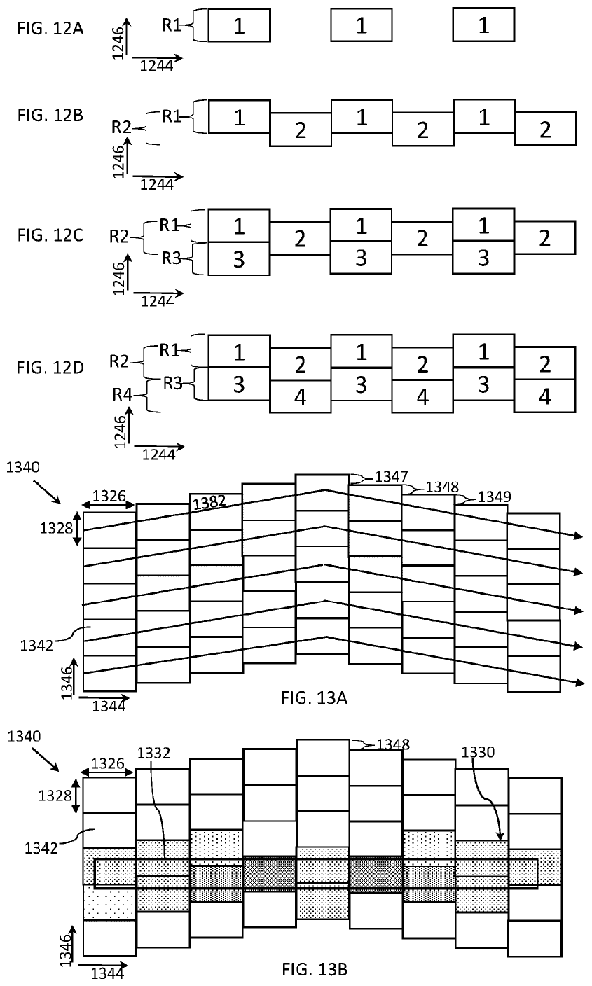

FIGS. 12A-D are simplified schematics illustrating successive acquisition of pixels of a LIDAR pixel grid, according to some embodiments of the disclosure.

In some embodiments, offset grids e.g., as illustrated in FIGS. 3A-C, and FIGS. 12A-D are produced by, referring back to FIG. 11, during step 1101, total movement (e.g. where movements are continuous) between pulse emissions corresponds to a double a pixel size in the first direction 1244 e.g., illuminating, every “even” pixel position. For example, referring to FIG. 12A where pixels (each numbered “1”) of a first row R1 are produced.

Where, at 1106, movement is of half pixel size in the second direction 1246, where then, again at step 1101, “odd” pixel positions are illuminated by positioning a start of the odd pixel line at a pixel width away from a start to the first row. Illuminating, every “odd” pixel position. For example, referring to FIG. 12B where pixels (each numbered “2”) of a second row R2 are produced.

In some embodiments, movement along rows is in a consistent direction (e.g., referring to FIGS. 12A-D, from left to right). In some embodiments, the movement along rows alternates in sign e.g., from left to right, followed by from right to left then vice versa.

FIGS. 13A-B are simplified schematics of a LIDAR pixel grid 1340, according to some embodiments of the disclosure.

Where, in some embodiments, direction of movement of the laser spot along rows of pixel grid 1340 indicated by arrows 1382. An offset grid being constructed moving the laser spot in two directions 1344, 1346. Where, in some embodiments, the movement in between emissions for a row is by a first pixel dimension 1326 in a first direction 1344. Where, in some embodiments, the movement includes an offset 1348 where offset 1358 is less than a second pixel dimension 1328. The two movements placing adjacent pixels (e.g., each adjacent pixel) of one or more row (e.g., each row) offset from each other.

FIG. 13B illustrates grid 1340 detecting an object 1332. In some embodiments, offset 1348 is less than half a pixel dimension 1328 in a direction of the offset, a potential advantage being, for objects which extend through a plurality of pixels in a direction perpendicular to the offset, a plurality of sub-pixel dimension height options e.g., as opposed to offset by half a pixel dimension which provides a single sub-pixel dimension possibility per pixel.

### Exemplary Multi-Beam Configurations

In some embodiments, one or more scanning method as described in this document is performed using a LIDAR system having multiple scanning beams. Where, in some embodiments, for example, at a same time and/or at a time separation shorter than that required for sensing, more than one measurement light pulse is emitted from the LIDAR system. Where, in some embodiments, the multiple light pulses are emitted in different directions and are detected separately e.g. to scan different portions of the LIDAR FOV during a same time period.

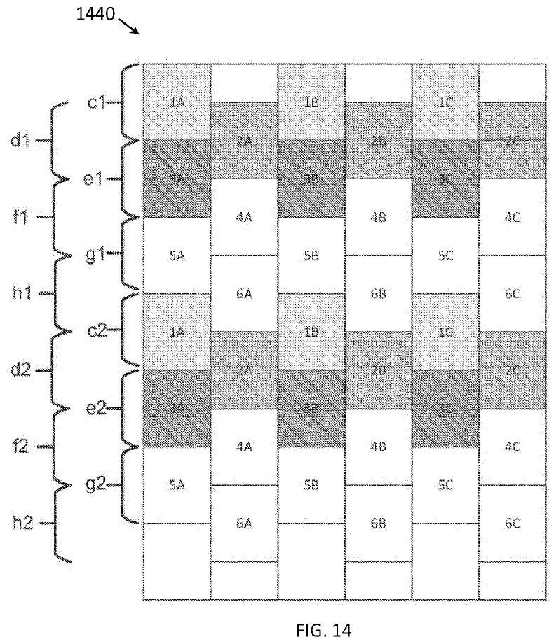

For example, FIG. 14 illustrates implementation of feature/s of scanning as described in FIGS. 12A-D using more than one scanning beam.

FIG. 14 is a simplified schematic of a LIDAR pixel grid 1440, according to some embodiments of the disclosure.

Where, in some embodiments, scan lines c1 and c2 are scanned by a first beam and a second beam respectively, e.g. at the same time. In some embodiments, scan lines d1 and d2 are then scanned by first and second beams respectively e.g. at the same time and so on.

Other scanning methods e.g. the method illustrated in FIG. 13A, in some embodiments, are performed by multiple beams.

### General

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

The terms “comprises”, “comprising”, “includes”, “including”, “having” and their conjugates mean “including but not limited to”. The term “consisting of” means “including and limited to”. As used herein, singular forms, for example, “a”, “an” and “the” include plural references unless the context clearly dictates otherwise. Within this application, various quantifications and/or expressions may include use of ranges. Range format should not be construed as an inflexible limitation on the scope of the present disclosure. Accordingly, descriptions including ranges should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within the stated range and/or subrange, for example, 1, 2, 3, 4, 5, and 6. Whenever a numerical range is indicated within this document, it is meant to include any cited numeral (fractional or integral) within the indicated range.

It is appreciated that certain features which are (e.g., for clarity) described in the context of separate embodiments, may also be provided in combination in a single embodiment. Where various features of the present disclosure, which are (e.g., for brevity) described in a context of a single embodiment, may also be provided separately or in any suitable sub-combination or may be suitable for use with any other described embodiment. Features described in the context of various embodiments are not to be considered essential features of those embodiments, unless the embodiment is inoperative without those elements. Although the present disclosure has been described in conjunction with specific embodiments thereof, it is evident that many alternatives, modifications, and variations will be apparent to those skilled in the art. Accordingly, this application intends to embrace all such alternatives, modifications and variations that fall within the spirit and broad scope of the appended claims. All references (e.g., publications, patents, patent applications) mentioned in this specification are herein incorporated in their entirety by reference into the specification, e.g., as if each individual publication, patent, or patent application was individually indicated to be incorporated herein by reference. Citation or identification of any reference in this application should not be construed as an admission that such reference is available as prior art to the present disclosure. In addition, any priority document(s) and/or documents related to this application (e.g., co-filed) are hereby incorporated herein by reference in its/their entirety. Where section headings are used in this document, they should not be interpreted as necessarily limiting.

1. A method of processing LIDAR measurement data comprising:
receiving the LIDAR measurement data including object pixel data corresponding to measurement of an object, the object pixel data including a plurality of data pixels corresponding to an edge of the object, the plurality of data pixels including at least two pixels adjacent to each other in a first direction where the at least two pixels are offset from each other in a second direction by an offset distance which is less than a dimension of at least one of the at least two pixels in a second direction, where at least one outer pixel of the at least two pixels extends by the offset away from an outer edge of at least one inner pixel of the at least two pixels;
determining a location of the edge of the object as located within an outer edge of the at least one inner pixel, to truncate an extent of the object from that of the plurality of data pixels.

2. The method according to claim 1, wherein the outer pixel is truncated by the offset distance.

3. The method according to claim 1, wherein each pixel of the object pixel data has a first pixel dimension in the first direction and a second pixel dimension in the second direction, the offset being less than the second pixel dimension.

4. The method according to claim 3, wherein the first direction corresponds to a horizontal direction, the second direction corresponds to a vertical direction, the first pixel dimension is a pixel width and the second pixel dimension is a pixel height.

5. The method according to claim 1, comprising determining a confidence level of the location of the edge of the object.

6. The method according to claim 5, wherein the object pixel data comprises reflection intensity data for one or more pixel of the object;
wherein the determining a confidence level comprises using the reflection intensity data.

7. The method according to claim 1, wherein the at least two pixels are adjacent to each other in the first direction, and the at least two pixels are offset from each other in the second direction by the offset distance, for each distance away from a system providing the measurement data, for a range of distances.

8. The method according to claim 1, wherein the object pixel data comprises intensity data for one or more pixel of the object; wherein the determining the location of the edge of the object comprises using the intensity data.

9. The method according to claim 8, wherein the determining the location of the edge of the object comprises:
identifying one or more filled pixels of the object;
using an intensity value of the one or more filled pixels to determine a proportion of one or more edge pixels of the object pixel data filled by the object to determine the position of the edge.

10. The method according to claim 1, wherein the receiving comprises:
receiving a grid of measurement data, the grid corresponding to a field of view (FOV) of a LIDAR system and including a plurality of pixels; and
identifying the object pixel data as a cluster of activated pixels in the grid.

11. The method according to claim 10, wherein the measurement data includes reflection intensity, for each pixel of the grid; and
wherein an activated pixel is a grid pixel having a reflection intensity of over a threshold intensity.

12. The method according to claim 1, wherein, for a distance of the object from the LIDAR system required for obstacle avoidance at a speed of movement of the LIDAR system, double the pixel second dimension is larger in size than a height of an over-drivable obstacle.

13. (canceled)

14. The method according to claim 1, wherein the receiving comprises acquiring measurement data by scanning pulses of laser light across a field of view (FOV) and sensing reflections of the pulses of laser light from one or more object within the FOV.

15. The method according to claim 14, wherein illumination of the pulses of laser light is selected so that, for a range of measurement distances, pulses continuously cover the FOV.

16. The method according to claim 14, wherein the scanning comprises: scanning a first scan line where FOV pixels are aligned horizontally; and
scanning a second scan line where FOV pixels are positioned vertically between FOV pixels of the first scan line and displaced by a proportion of a pixel height.

17. The method according to claim 14, wherein the scanning comprises, scanning a row where, between emissions of the pulses of laser light, changing a direction of emission in a first distance in a first direction and a second distance in a second direction, where for a first portion of the row, the first distance is a positive value in the first direction and the second distance is a positive value in the second direction and for a second portion of the row, the first distance is a negative value in the first direction and the second distance is a positive value in the second direction.

18. The method according to claim 17, wherein the changing a direction of emission comprises rotating a deflector, where rotation around a first axis changes direction of emission in the first direction and rotation around a second axis changes direction of emission in the second direction.

19. The method according to claim 18, wherein changing a direction of emission comprises receiving a control signal driving the rotation.

20-31. (canceled)

32. A LIDAR system comprising:
a light source and a sensor configured to acquire measurement data;
a processor configured to:
receive said measurement data and to generate therefrom object pixel data corresponding to measurement of an object, the object pixel data including a plurality of data pixels corresponding to an edge of the object, the plurality of data pixels including at least two pixels adjacent to each other in a first direction where the at least two pixels are offset from each other in a second direction by an offset distance which is less than a dimension of at least one of the at least two pixels in a second direction, where at least one outer pixel of the at least two pixels extends by the offset away from an outer edge of at least one inner pixel of the at least two pixels;
determine a location of the edge of the object as located within an outer edge of the at least one inner pixel, to truncate an extent of the object from that of the plurality of data pixels.

33. The LIDAR system according to claim 32 comprising:
a deflector configured to direct light pluses from the light source towards a field of view (FOV), each pulse corresponding to a FOV pixel having a pixel first dimension in a first direct and a pixel second dimension in a second direction;
wherein said light source is configured to emit pulses of light;
wherein said sensor is configured to sense intensity of the light pulses reflected from objects within the FOV;
wherein said processor is configured to:
control the deflector to direct the light pulses to scan the FOV where adjacent FOV pixels in the first direction are displaced by an offset in the second direction from each other by a proportion of the pixel dimension; and
identify an object within the FOV as a cluster of the FOV pixels having higher intensity, the cluster forming said object pixel data.
